(19) United States
(12) Patent Application Publication
(10) Pub. No.: US 2017/0118475 A1
(43) Pub. Date: Apr. 27, 2017

(54) Method and Apparatus of Video Compression for Non-stitched Panoramic Contents

(71) Applicant: MediaTek Inc., Hsin-Chu (TW)

(72) Inventors: Tsui-Shan CHANG, Tainan City (TW); Yu-Hao HUANG, Kaohsiung City (TW); Chih-Kai CHANG, Taichung City (TW); Tsu-Ming LIU, Hsinchu City (TW); Chi-Cheng JU, Hsinchu City (TW); Kai-Min YANG, Kaohsiung City (TW)

(21) Appl. No.: 15/284,390

(22) Filed: Oct. 3, 2016

Related U.S. Application Data
(60) Provisional application No. 62/244,815, filed on Oct. 22, 2015.

(51) Int. Cl. H04N 19/159; H04N 19/186; H04N 19/85; H04N 19/176

(52) U.S. Cl. CPC H04N 19/159; H04N 19/176; H04N 19/186; H04N 19/85

(57) ABSTRACT

Methods and apparatus of compression for non-stitched pictures captured by multiple cameras of a panoramic video capture device are disclosed. According to one embodiment, the system uses a RIBC (Remapped Intra Block Copy) mode, where the block vector (BV) or BV predictor is remapped using calibration data to reduce the search range. The mapped BV or BVP is also more efficient for coding. A color scaling process can be used with the RIBC mode to compensate the color/brightness discrepancy between images from different cameras. A projection-based Inter prediction method is also disclosed. The projection-based Inter prediction method takes into account different perspectives between two images captured from different cameras. Transform matrix is applied to a block candidate to project the block candidate to a position of a target block. The projected block candidate is used as a predictor for the target block.

### CROSS REFERENCE TO RELATED APPLICATIONS

The present invention claims priority to U.S. Provisional Patent Application Ser. No. 62/244,815, filed on Oct. 22, 2015. The U.S. Provisional patent application is hereby incorporated by reference in its entirety.

### FIELD OF THE INVENTION

The present invention relates to video coding. In particular, the present invention relates to techniques of video compression for non-stitched pictures generated from multiple cameras of a panoramic video capture device.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a set of cameras, arranged to capture 360-degree field of view. The set of cameras may consist of as few as one camera. Nevertheless, typically two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

The set of cameras have to be calibrated to avoid possible misalignment. Calibration is a process of correcting lens distortion and describing the transformation between world coordinate and camera coordinate. The calibration process is necessary to allow correct stitching of videos. Individual video recordings have to be stitched in order to create one 360-degree video. Stitching of pictures has been well studied in the field via the context of blending or seam processing.

FIG. 1 illustrates an example of images from panoramic videos corresponding to a given time instance. The panoramic videos are captured using four cameras, where the principle axis of each camera is rotated roughly 90° from that of a neighboring camera. The set of four non-stitched images 110 consists of four images (112, 114, 116 and 118) from four cameras. Each camera covers very wide field of view (i.e., using wide angle lens) so that pictures from neighboring cameras have a substantial overlapped area. The set of pictures corresponding to the panoramic videos at a given instance are then stitched to form a pre-stitched picture 120. A pre-stitched picture 120 is a stitched picture that is stitched prior to enter the video compression system for subsequent compression.

For panoramic video, in particular, the 360-degree video, multiple videos may be captured using multiple cameras. A large amount of bandwidth or storage will be needed for the data necessary to render a full virtual reality environment. With the ever increasing video resolutions, the required bandwidth or storage becomes formidable. Therefore, it is desirable to develop efficient video compression techniques for the 360-degree video.

### BRIEF SUMMARY OF THE INVENTION

Methods and apparatus of compression for non-stitched pictures captured by multiple cameras of a panoramic video capture device are disclosed. Each non-stitched picture comprises at least two images captured by two cameras of the panoramic video capture device, and two neighboring images captured by two neighboring cameras include at least an overlapped image area. The present invention discloses encoding and decoding process that utilizes the calibration data that comprise camera parameters, feature detection results, or both, According to one embodiment for the encoder, calibration data associated with the panoramic video capture device are received from the panoramic video source data. When the calibration data exist, the current block in a current non-stitched picture is encoded using a RIBC (Remapped Intra Block Copy) mode. The RIBC encoding process comprises: modifying a first search area corresponding to previously coded area of the current non-stitched picture to a second search area according to the calibration data, wherein the second search area is smaller than the first search area; searching candidate blocks within the second search area to select a best matched block with the current block; remapping a BV (block vector) into a mapped BV according to the calibration data, wherein the BV represents displacement from the current block to the best matched block; encoding the current block into coded current block using the best matched block as a predictor; and generating compressed data comprising the coded current block and the mapped BV for the current block.

If the video encoding system uses a normal IBC mode separated from the RIBC mode, the RIBC encoding process is omitted when the calibration data do not exist. If the RIBC mode is used jointly with a normal IBC process, a normal IBC encoding process is applied to the current block when the calibration data do not exist.

For the decoding side, calibration data are parsed from the compressed data. When the calibration data exist, the current block is decoded using the RIBC mode. The RIBC decoding process comprises: deriving a mapped BV for the current block from the compressed data; remapping the mapped BV into a BV according to the calibration data; locating a best matched block in the previously decoded picture area of the current non-stitched picture using the BV, wherein the BV represents displacement from the current block to the best matched block; and reconstructing the current block from the coded current block using the best matched block as a predictor. If the compressed data are generated by a video encoding system using the RIBC mode jointly with a normal IBC process, a normal IBC decoding process is applied to the current block when the calibration data do not exist.

The calibration data may comprise one or more camera parameters, one or more feature detection results or both, which are generated during camera calibration stage. The camera parameters are selected from a group comprising camera position, FOV (field of view), intrinsic parameters and extrinsic parameters. The feature detection results are selected from a group comprising feature position and matching relation. The calibration data can be included in the panoramic video source data so that the encoder can parse the calibration data from the panoramic video source data. Furthermore, the encoder can encode the calibration data to include it in the compressed data for the decoder to retrieve the calibration data.

Furthermore, the coding system can include color scaling process to adjust intensity discrepancy between cameras. In the encoder side, the color scaling process can be applied to the candidate blocks. The color scaling process scales pixel values for each color component according to a scaling formula to generate scaled pixel values, wherein the scaling formula is specified by one or more scaling parameters. For example, the scaling formula corresponds to multiplying a given pixel value by a multiplication factor and then adding an offset value. The scaling parameters can be encoded into the compressed data at the encoder side so that the decoder can retrieve the scaling parameters.

The present invention also discloses projection-based prediction for the non-stitched pictures. In the encoder side, the current block is encoded using a projection-based Inter prediction mode when the calibration data exist. The projection-based Inter prediction encoding process comprises: projecting candidate blocks within a search area into projected candidate blocks according to a projection model using the calibration data; searching projected candidate blocks within the search area to select a best matched block for the current block; encoding the current block into coded current block using the best matched block as a predictor; and generating compressed data comprising the coded current block. The search area may be within a previously coded area of the current non-stitched picture. In this case, projecting candidate blocks within the search area into projected candidate blocks applies a translation matrix to the candidate blocks, where the translation matrix represents position relation between two neighboring cameras of the panoramic video capture device. The search area may be within a reference non-stitched picture that is coded prior to the current non-stitched picture. In this case, projecting candidate blocks within the search area into projected candidate blocks applies a translation matrix to the candidate blocks, where the translation matrix represents global motion of non-stitched pictures. The video encoding system may use a normal Inter prediction mode separated from the projection-based Inter prediction mode, and the projection-based Inter prediction encoding process is omitted when the calibration data do not exist. In another embodiment, the projection-based Inter prediction mode is used jointly with a normal Inter prediction mode, and a normal Inter prediction encoding process is applied to the current block when the calibration data do not exist. In the decoder side, when a best matched block is derived from the compressed data, the best matched block is projected to a projected best matched block using the calibration data. The projected best matched block is then used as a predictor for reconstructing the current block.

### BRIEF DESCRIPTION OF THE DRAWINGS

FIG. 1 illustrates an example of non-stitched picture from panoramic videos, where each non-stitched picture consists of four images captured by four different cameras of the panoramic video capture device.

FIG. 2 illustrates an example of redundancy in the non-stitched images captured by a panorama camera with 360-degree field of view.

FIG. 3A illustrates an exemplary video encoder according to existing advanced video coding standards such as High Efficiency Video Coding (HEVC), which utilizes adaptive Inter Prediction and Intra Prediction.

FIG. 3B illustrates an exemplary video decoder according to existing advanced video coding standards such as High Efficiency Video Coding (HEVC), which utilizes adaptive Inter Prediction and Intra Prediction.

FIG. 4A illustrates an exemplary block diagram for a video encoder incorporating an embodiment of the present invention, where the Remapping Intra Block Copy (RIBC) mode is a separate mode from the IBC mode.

FIG. 4B illustrates an exemplary block diagram for another video encoder incorporating an embodiment of the present invention, where a joint remapping IBC mode and IBC mode is used.

FIG. 5A illustrates an example of the redundant block vector (BV), where the actual BV can be coded by subtracting the redundant BV.

FIG. 5B illustrates an example of remapping a block vector according to an embodiment of the present invention.

FIG. 6 illustrates an exemplary flowchart of the Remapping IBC (RIBC) encoding process for an encoder in FIG. 4A, which uses separate RIBC mode and IBC mode.

FIG. 7 illustrates an exemplary flowchart of the Remapping IBC (RIBC) decoding process for a decoder corresponding to the encoder in FIG. 4A, which uses separate RIBC mode and IBC mode.

FIG. 8 illustrates an exemplary flowchart of the Remapping IBC (RIBC) encoding process for an encoder in FIG. 4B, which uses a joint RIBC and IBC mode.

FIG. 9 illustrates an exemplary flowchart of the Remapping IBC (RIBC) decoding process for a decoder corresponding to the encoder in FIG. 4B, which uses a joint RIBC and IBC mode.

FIG. 10A illustrates an example of conventional IBC, where the search range can be equal to the picture width.

FIG. 10B illustrates an example of Remapping IBC according an embodiment of the present invention, where the search range is reduced using the calibration data.

FIG. 11 illustrates an example of color/brightness discrepancies between two images captured by two different cameras in a panoramic video capture device.

FIG. 12A illustrates an exemplary block diagram for a video encoder incorporating an embodiment of the present invention, where the remapping IBC mode is a separate mode from the IBC mode, and the RIBC process further includes a color scaling process.

FIG. 12B illustrates an exemplary block diagram for another video encoder incorporating an embodiment of the present invention, where a joint remapping IBC mode and IBC mode is used, and the RIBC process further includes a color scaling process.

FIG. 13 illustrates an example of color scaling for compression of non-stitched pictures from two neighboring cameras with overlapped field of view.

FIG. 14 illustrates an exemplary flowchart of the Remapping IBC (RIBC) encoding process for an encoder in FIG. 12A, which uses separate RIBC mode and IBC mode, and the RIBC process further includes a color scaling process.

FIG. 15 illustrates an exemplary flowchart of the Remapping IBC (RIBC) decoding process for a decoder corresponding to the encoder in FIG. 12A, which uses separate RIBC mode and IBC mode, and the RIBC process further includes a color scaling process.

FIG. 16 illustrates an exemplary flowchart of the Remapping IBC (RIBC) encoding process for an encoder in FIG. 12B, which uses joint RIBC and IBC mode, and the RIBC process further includes a color scaling process.

FIG. 17 illustrates an exemplary flowchart of the Remapping IBC (RIBC) decoding process for a decoder corresponding to the encoder in FIG. 12B, which uses joint RIBC and IBC mode, and the RIBC process further includes a color scaling process.

FIG. 18 illustrates an example of distortion between two images captured by two different cameras with different perspectives.

FIG. 19 illustrates an example of the projection-based prediction process according to an embodiment of the present invention.

FIG. 20A illustrates an exemplary block diagram for a video encoder incorporating projection-based Inter prediction according to an embodiment of the present invention, where separate projection-based Inter prediction mode and conventional Inter prediction mode are used.

FIG. 20B illustrates an exemplary block diagram for a video encoder incorporating projection-based Inter prediction according to an embodiment of the present invention, where joint projection-based and conventional Inter prediction mode is used.

FIG. 21 illustrates an exemplary flowchart of projection-based Inter prediction process for an encoder in FIG. 20A, which uses separate projection-based Inter prediction mode and conventional Inter prediction mode.

FIG. 22 illustrates an exemplary flowchart of projection-based Inter prediction process for a decoder corresponding to the encoder in FIG. 20A, which uses separate projection-based Inter prediction mode and conventional Inter prediction mode.

FIG. 23 illustrates an exemplary flowchart for an encoder in FIG. 20B, which uses a joint projection-based and conventional Inter prediction mode.

FIG. 24 illustrates an exemplary flowchart of projection-based Inter prediction process for a decoder corresponding to the encoder in FIG. 20B, which uses a joint projection-based and conventional Inter prediction mode.

FIG. 25A illustrates an example of a 360-degree picture based on the equirectangular projection, where the images are mapped to a flat image.

FIG. 25B illustrates an example of a 360-degree picture based on the cubic projection, where the images are arranged like the faces of a cube.

FIG. 26 illustrates an example of spherical video pre-processing flow comprising stitching, blending and orientation.

FIG. 27 illustrates an example of cloud-based processing of 360-degree video according to one embodiment of the present invention.

FIG. 28 illustrates and example of a frame of 360-degree video, where the frame consists of four images.

FIG. 29 illustrates an example of the 360-degree video transmission system according to one embodiment of the present invention.

FIG. 30 illustrates an example of detailed panoramic post-processing unit according to one embodiment of the present invention, where the panoramic post-processing includes stitching, blending, and orientation process.

FIG. 31 illustrates an example of the effect of blending process, where the seam is substantially reduced.

FIG. 32 illustrates an example of the effect of orientation process, where the orientation of an input picture is properly adjusted to display the sky on the top and the floor on the bottom.

FIG. 33 illustrates an exemplary flowchart of video encoding of non-stitched pictures using a remapping IBC mode in a video encoder according to an embodiment of the present invention.

FIG. 34 illustrates an exemplary flowchart of video decoding of non-stitched pictures using a remapping IBC mode in a video decoder according to an embodiment of the present invention.

FIG. 35 illustrates an exemplary flowchart of video encoding of non-stitched pictures using a projection-based Inter prediction mode in a video encoder according to an embodiment of the present invention.

FIG. 36 illustrates an exemplary flowchart of video decoding of non-stitched pictures using a projection-based Inter prediction mode in a video decoder according to an embodiment of the present invention.

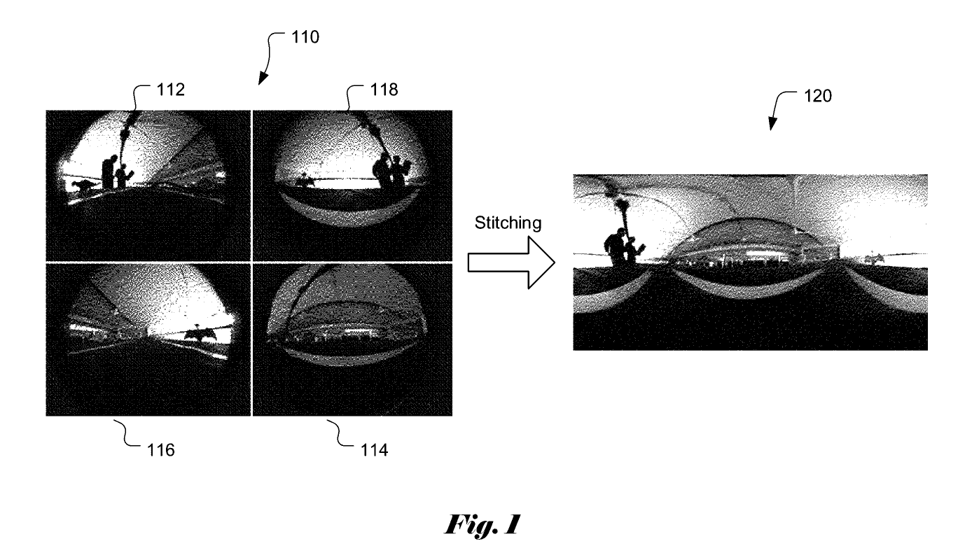

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, 360-degree videos usually are captured using multiple cameras associated with separate perspectives. Individual video recordings have to be stitched in order to create a 360-degree video. The stitching process is rather computationally intensive. Therefore, the stitching process is often performed in a non-real time fashion, where the individual videos have to be transmitted or stored for a later stitching process. Alternatively, the stitching process can be performed on a high-performance device instead of a local device that captures the 360-degree video. For example, the stitching task can be performed by a cloud server or other devices for videos captured by a mobile panoramic capture device, such as an immersive camera. Depending on the number of cameras used for capturing the 360-degree panoramic videos, the number of videos to be transmitted or stored may be very large and the videos will require very high bandwidth or very large storage space. The individual videos captured using multiple cameras before stitching are referred as non-stitched video in this disclosure.

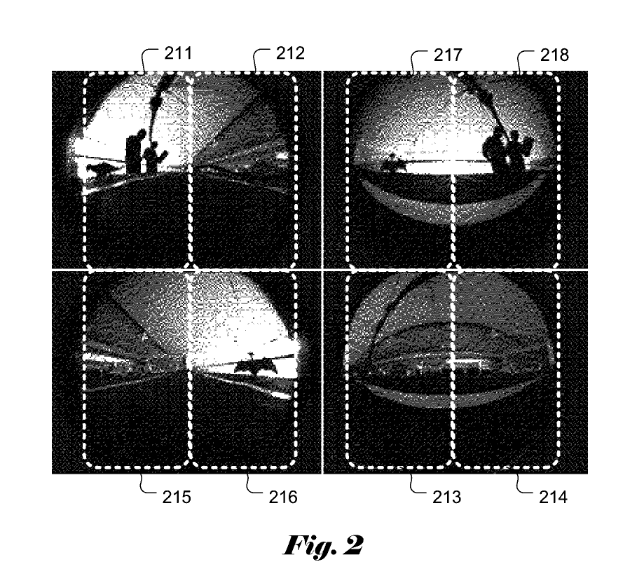

The multiple cameras used for panoramic videos are often arranged so that two neighboring cameras have overlapped field of view. For objects in the overlapped field of view may appear in both associated videos. Accordingly, there is a certain degree of redundancy within the corresponding panoramic videos and such redundancy is referred as inter-lens redundancy in this disclosure. FIG. 2 illustrates an example of redundancy in the non-stitched images captured by a panorama camera with 360 degree field of view. The panorama camera has four cameras. The picture regions corresponding to overlapped areas are indicated as dashed boxes (211-218). Picture regions 212 and 213 correspond to one overlapped area. Picture regions 214 and 215 correspond to another overlapped area. Picture regions 216 and 217 correspond to yet another overlapped area. Picture regions 218 and 211 correspond to yet another overlapped area. The present invention discloses methods to explore the inter-lens redundancy in order to improve the coding efficiency of the panoramic videos.

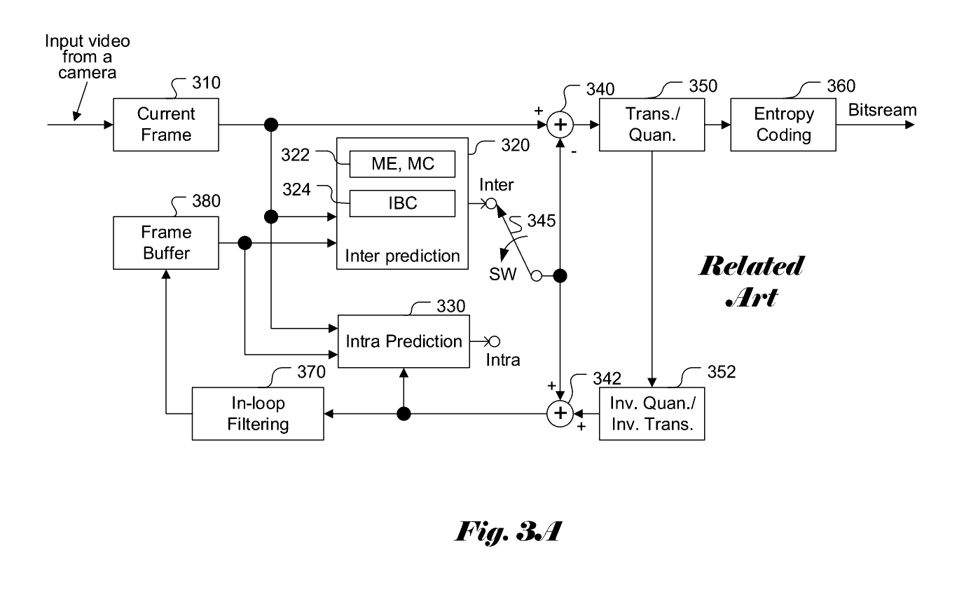

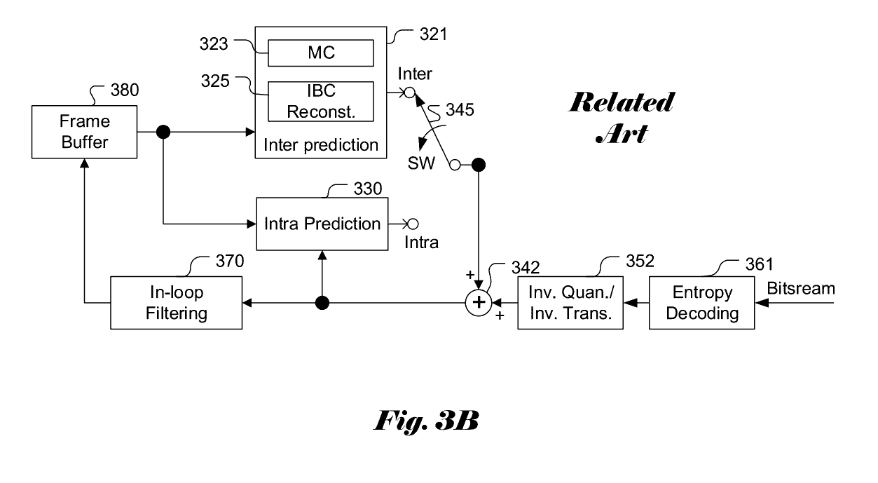

FIG. 3A illustrates an exemplary video encoder according to existing advanced video coding standards such as High Efficiency Video Coding (HEVC), which utilizes adaptive Inter Prediction 320 and Intra Prediction 330. The Inter Prediction 320 supports the conventional Inter-prediction mode 322 that utilizes motion estimation (ME) and motion compensation (MC) to generate temporal prediction for a current frame 310 based on previous reconstructed picture or pictures. The previous reconstructed pictures, also referred as reference pictures, are stored in the Frame Buffer 380. Intra Block Copy (IBC) 324 is a new Inter prediction tool available for HEVC extension, where the IBC 324 operates in a similar fashion as the convention Inter prediction. However, for the IBC mode, the reference picture is the current picture. A block vector (BV), instead of motion vector (MV), is used to locate a reference block in the reconstructed region of the current picture. A switch SW 345 is used to select between the Inter prediction 320 and the Intra Prediction 330. The selected prediction is subtracted from the corresponding signal of the current frame to generate prediction residuals using an Adder 340. The prediction residuals are processed using Transform and Quantization (Trans./Quan.) 350 followed by Entropy Coding 360 to generate video bitstream. Since reconstructed pictures are also required in the encoder side to form reference pictures. Accordingly, Inverse Quantization and Inverse Transform (Inv. Trans./Inv. Quan.) 352 are also used to generate reconstructed prediction residuals. The reconstructed residuals are then added with the prediction selected by the switch SW 345 to form reconstructed video data associated with the current frame. In-loop Filtering 370 such as deblocking filter and Sample Adaptive offset (SAO) are often used to reduce coding artifacts due to compression before the reconstructed video is stored in the Frame Buffer 380. In the conventional video encoder for the panoramic videos, the individual video is compressed individually without reference to other videos captured by other cameras. A video decoder as shown in FIG. 3B corresponding to the encoder in FIG. 3A can be formed similar to the reconstruction loop used by the encoder. However, an entropy decoder 361 will be required instead of an entropy encoder. Furthermore, only motion compensation 323 and IBC reconstruction 325 are required for Inter prediction 321 since the motion vectors and block vectors can be derived from the video bitstream.

The present invention discloses encoding and decoding process that utilizes the calibration data that comprise camera parameters, feature detection results, or both. According to the present invention, the calibration data is used by at least one operation used in the encoding process or decoding process. In the following, various examples are illustrated how the calibration data is used to help improve the compression efficiency or speed up the required operations related to non-stitched picture compression. In particular, one example is shown how the calibration data is used for Intra Block Copy (IBC) mode to improve the processing speed associated with IBC block vector (BV) search. In another example, the calibration data is used to rectify the distortion between pictures captured by cameras with different perspectives in order to improve compression efficiency. While the following examples are illustrated to demonstrate how calibration data are used in video encoder and decoder to compress non-stitched pictures, these particular examples shall not construed as limitations to the present invention.

For panoramic video, the pictures captured at a same instance contain certain same objects in the overlapped area, but in different perspectives. The Intra Block Copy (IBC) coding tool developed for HEVC SCC (Screen Content Coding) extension addresses redundancy within difference areas of the same picture, particularly the pictures corresponding to screen contents. While the redundancy in the panoramic pictures appear to be similar to the redundancy in different areas of a same picture, the IBC coding tool does not work well for the panoramic pictures since the objects in the overlapped area are captured by different cameras from different perspectives. Accordingly, the present invention discloses a new technique, named Remapping Intra Block Copy (RIBC), to address the redundancy in the non-stitched pictures from panoramic videos.

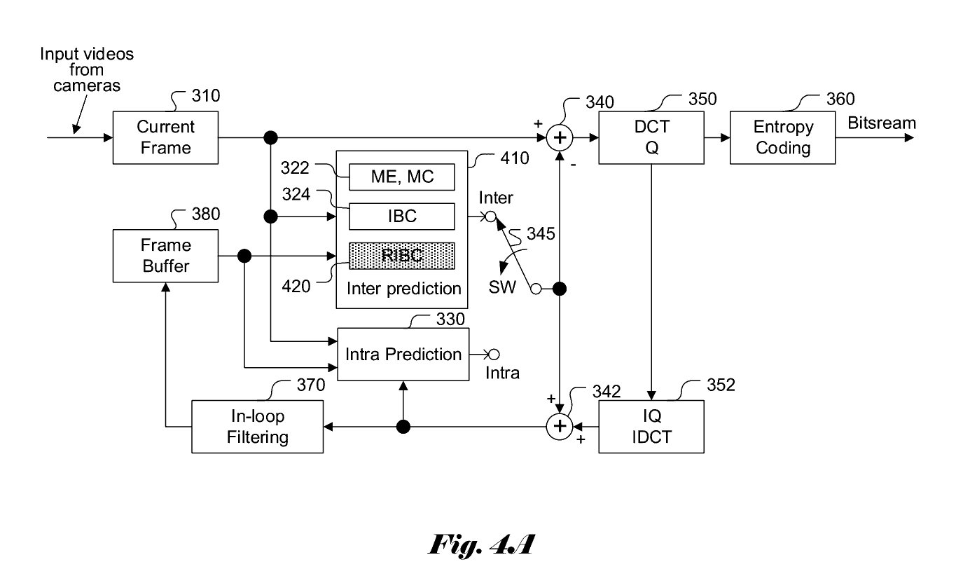

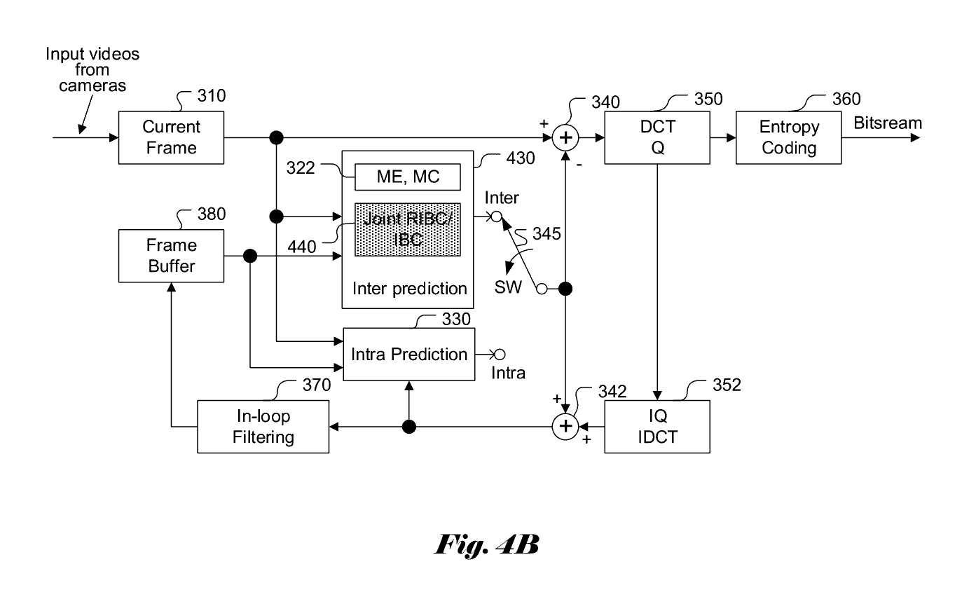

FIG. 4A illustrates an exemplary block diagram for a video encoder incorporating an embodiment of the present invention, where Inter Prediction 410 further includes Remapping Intra Block Copy (RIBC) 420. In other words, the additional coding tool—RIBC 420 is available for the embodiment. In FIG. 4A, the RIBC mode is a mode separated from the IBC mode. When Inter prediction is used, the encoder selects among the conventional Inter prediction based on ME/MC 322, the IBC 324 and RIBC 420.

FIG. 4B illustrates an exemplary block diagram for another video encoder incorporating an embodiment of the present invention, where Inter Prediction 430 includes a joint RIBC/IBC process 440. In this case, when Inter prediction is used, the encoder selects between the conventional Inter prediction based on ME/MC 322 and the joint RIBC/IBC 440. When the joint RIBC/IBC 440 is selected, the encoder further decides between RIBC and IBC modes. A decoder corresponding to the encoder in FIG. 4A is similar to the decoder in FIG. 3B. However, an additional RIBC reconstruction mode is supported.

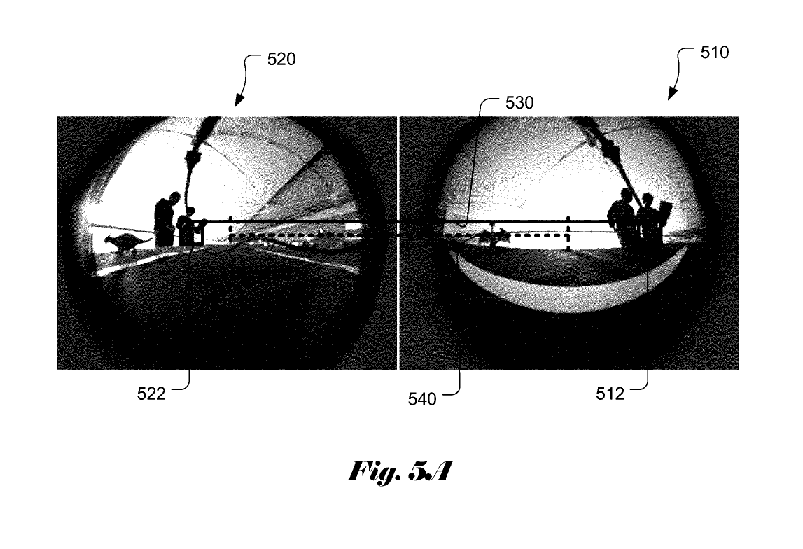

When IBC is used, the corresponding block in the center of two neighboring pictures can be determined according to the camera model. Therefore, the range of block vector corresponding to the two centers is known. Therefore, the BV for the two centers is considered redundant. FIG. 5A illustrates an example of the redundant BV. The actual BV 530 pointing from a reference block 522 in image 520 to a current block 512 in image 510 of the non-stitched picture can be coded by subtracting the redundant BV 540. When RIBC is used, the calibration data can be used to remap the BVs and reduce the search range. FIG. 5B illustrates an example of remapping BV according to an embodiment of the present invention. In the top half, the dash-lined box 550 indicates the reconstructed area for coding the current block 512. If the BV search is performed only in the horizontal direction, the maximum search range can be rather large to find a best block vector (BV) 530. However, if BV remapping is used, the search for the matched BV can be reduced to an area 560 to refine the BV search. In this case, the maximum search range can be substantially reduced. The BV 565 can be measured from the upper-left corner of the search area 560 to the upper-left corner of the best matched block. However, other coordinate system may be used as well.

The Remapping Intra Block Copy (RIBC) process utilizes calibration data, which are generated in the camera calibration stage. The calibration data comprise camera parameters, feature detection results or other related data. Camera parameters include intrinsic parameters, extrinsic parameters, camera position, FOV (field of view), or any combination of them. Feature detection results comprise feature position and matching relation. The extrinsic parameters describe the camera positions and the transformation between the world coordinate and the camera coordinate. In this case, the relation between the left and right camera positions can be determined through the extrinsic parameters. Furthermore, the positions that a certain object displays on these two image planes can also be determined in the calibration process. Thus, the matching relation between these two image planes is known and it can be utilized to remap the search range and BVs. The use of extrinsic parameters for remapping the search range and BVs is known in the field. The techniques related to calibration data derivation and feature detection are known in the literature (e.g. Hartley et al., Multiple View Geometry in Computer Vision. Cambridge University Press. 2003, pp. 153-158. ISBN 0-521-54051-8, Z. Zhang, “A flexible new technique for camera calibration”, IEEE Transactions on Pattern Analysis and Machine Intelligence, Vol. 22, No. 11, pages 1330-1334, 2000 and Sturm et al., “On plane-based camera calibration: a general algorithm, singularities, applications”, In Proceedings of the IEEE Conference on Computer Vision and Pattern Recognition (CVPR), pages 432-437, Fort Collins, Colo., USA, June 1999). The details are not repeated here.

In the field of video coding, a block vector (BV) can be predictively coded using a BV predictor. Therefore, the BV prediction residual is signaled instead of the BV itself. Due to correlation between a BV to be coded and the properly selected BVP, the BV prediction residual is more efficient for compression. However, for coding of mapped pictures, a direct use of the BVP may not perform well due to different perspectives between images of the pre-stitched pictures. For example, area 211 and area 218 in FIG. 2 correspond to an overlapped area. Therefore, the block vector from area 211 can be used as a BVP for a corresponding block in area 218 if area 211 is coded prior to area 218. However, a BV for a block in area 211 may be very different from the BV for a corresponding block in area 218 due to different perspectives. In order to use the BV of a block in area 211 as a BVP for a corresponding block in area 218, the BVP has to be properly mapped before it is used as a BV predictor. After remapping, the mapped BVP will improve the BV prediction efficiency.

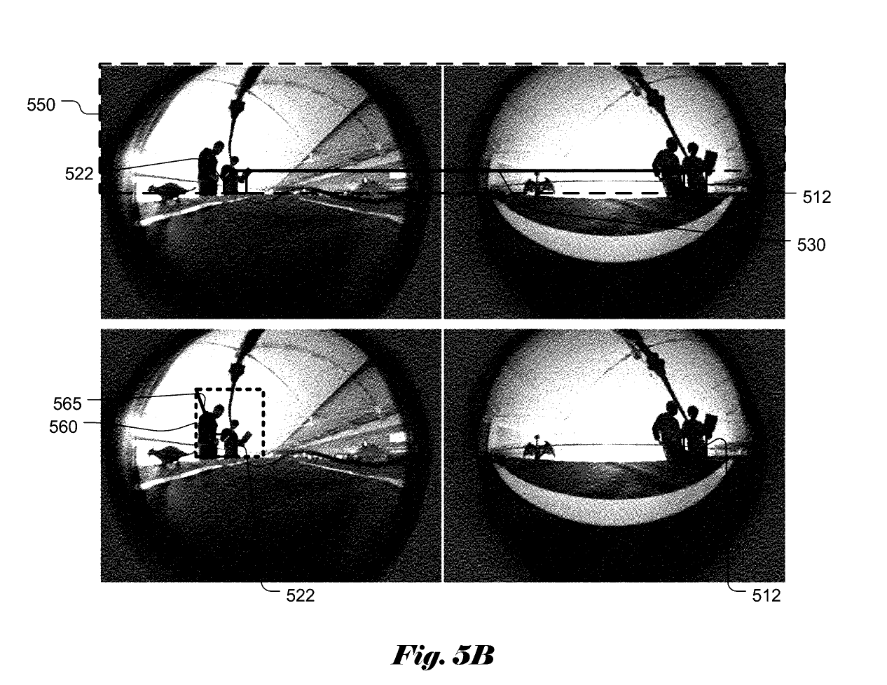

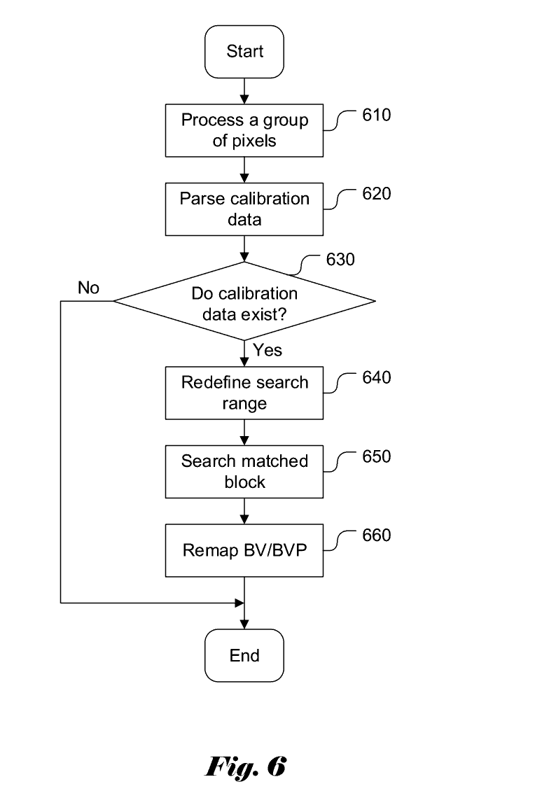

FIG. 6 illustrates an exemplary flowchart of the RIBC process for an encoder such as the one in FIG. 4A, which uses the RIBC mode and the IBC mode. When the RIBC mode is selected, a group of pixels are processed as shown in step 610. The group of pixels may correspond to a block, a coding unit (CU), a coding tree unit (CTU), a slice, or a picture. The input panoramic video data to be compressed may be stored in a certain format, which may not be suited for the intended compression. Therefore, certain processing, such as color conversion or data de-packing, may be needed. The process also parses the source data (step 620) to determine whether the calibration data exist (step 630). If the calibration data exist (i.e., the “yes” path), the search range is redefined (step 640), matched block is searched within the modified search range (step 650), and the block vector (BV) or BV predictor (BVP) is mapped according to the calibration data (step 660).

An exemplary flowchart of the RIBC process for a decoder using the RIBC mode is shown in FIG. 7. When the RIBC mode is selected, a group of coded pixels are processed as shown in step 710. The process in step 710 may correspond to parsing a group of coded pixels or even further reconstructing residuals for a group of pixels. Calibration data are parsed from the video bitstream as shown step 720. The BV/BVP derived from the video bitstream is then remapped according to the calibration data (step 730). A block is then reconstructed by using the mapped BV/BVP (step 740).

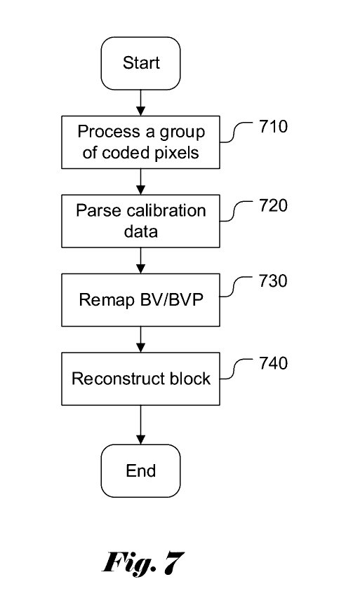

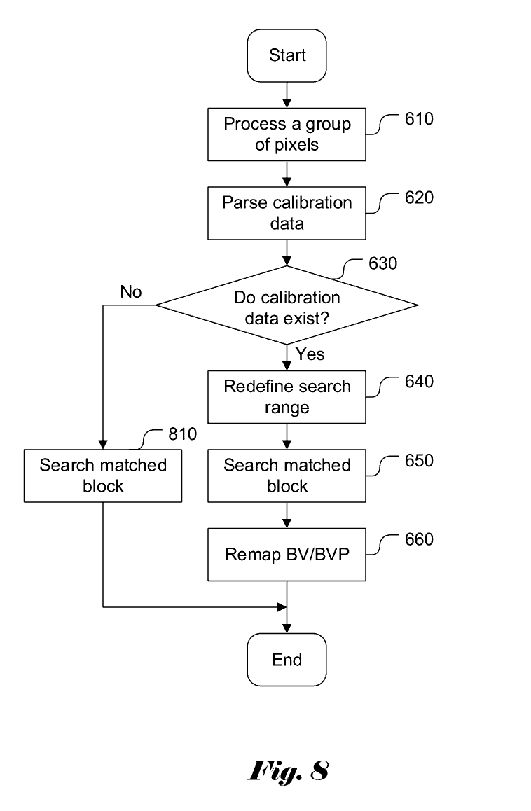

FIG. 8 illustrates an exemplary flowchart for another encoder similar to that in FIG. 6. Since the joint RIBC/IBC is used, the encoder uses the IBC mode when the calibration data do not exist. Therefore, the encoder search the matched block corresponding to IBC as shown in step 810.

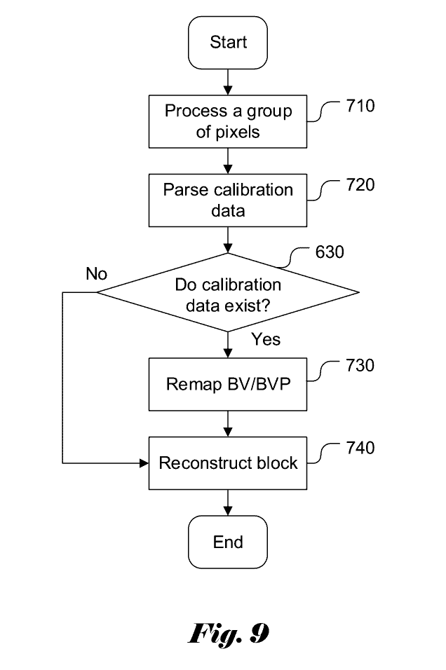

FIG. 9 illustrates an exemplary flowchart for another decoder similar to that in FIG. 7. However, when the calibration data do not exist, the encoder uses the IBC mode to reconstruct a block. Therefore, an additional test is performed in step 630 to determine whether the calibration data exist. If the calibration data exist (i.e., the “yes” path), the RIBC reconstruction is performed (i.e., IBC reconstruction using mapped BV/BVP). Otherwise, (i.e., the “no” path) the IBC reconstruction is performed (i.e., IBC reconstruction using regular BV/BVP).

The remapping technique mentioned above can also be applied to motion estimation/compensation in the temporal direction (i.e., temporal Inter prediction). For example, the motion search range can be redefined or the MV/MVP can be mapped using the camera parameters.

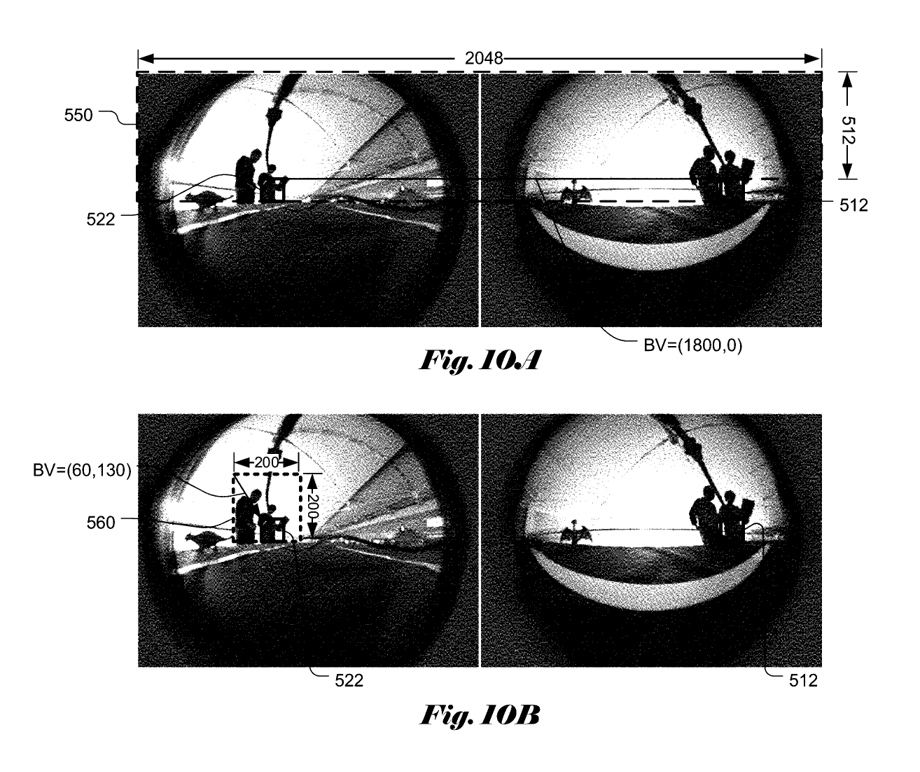

FIG. 10A illustrates an example of conventional IBC, where the original picture width is assumed to be 2048 pixels. The search range, as indicated by the dashed line area 550 for the current block 512, is about 2048×512. The matched block (522) is located by the block vector (BV) having a value equal to (1800, 0) in this example. FIG. 10B illustrates an example of RIBC according an embodiment of the present invention. The remapping technique reduces the search range down to (200×200) by using the calibration data according to the present invention in this example. The matched block (522) is located by the block vector (BV) having a remapped value equal to (60, 130) in this example. As mentioned before, the BV is redefined as a vector measured from the upper-left corner of the search area to the upper-left corner of the best matched block.

In the panoramic camera system, there may be some color and/or brightness variations between the multiple cameras used in the system. For the overlapped areas, the images captured by two neighboring cameras may have image characteristics. For example, the different images for a same overlapped area may have different brightness or colors. This variation may be caused by different camera ISP (Image Signal Processing) setting or camera positions. In this case, the IBC or RIBC may result in large residuals, which would lower the compression efficiency. FIG. 11 illustrates an example of brightness and color discrepancy in the overlapped area, where circles 1110 and 1120 indicate two corresponding regions in the overlapped area. As shown in FIG. 11, image contents in circle 1120 are much brighter than image contents in circle 1110. Also the color tone is shows some discrepancies.

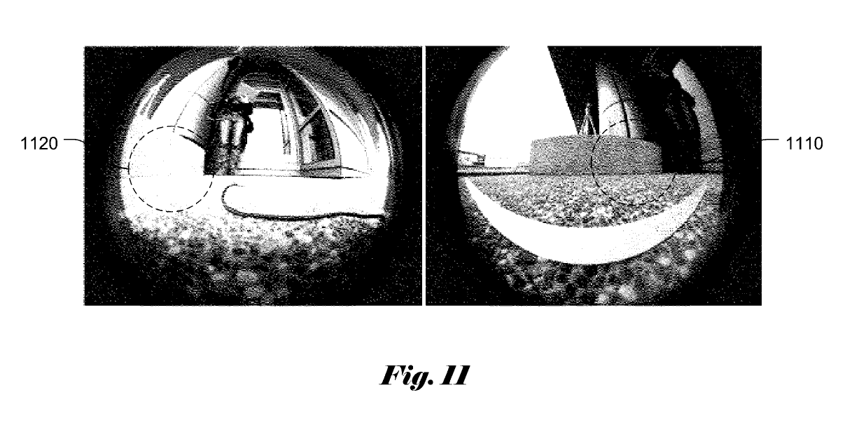

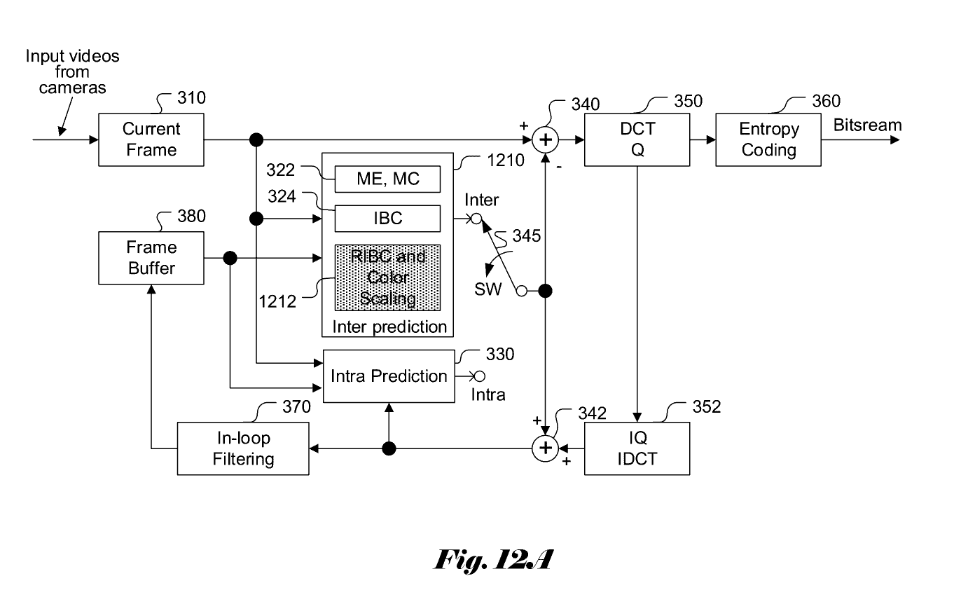

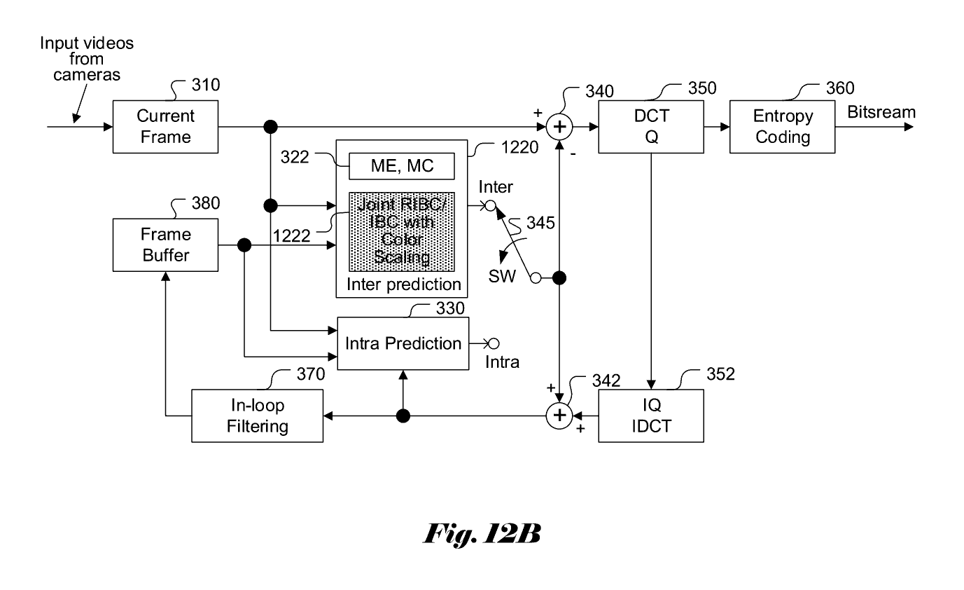

In order to alleviate the discrepancies in brightness and/or color between cameras, the present invention also includes a color scaling process. FIG. 12A illustrates an exemplary block diagram for a video encoder incorporating RIBC and color scaling according to an embodiment of the present invention. The encoder in FIG. 12A is similar to the encoder system in FIG. 4A except that the Inter prediction 1210 uses RIBC with Color Scaling 1212. The color scaling can be performed in the YUV color space (i.e., YUV scaling). The color scaling process can be performed jointly with RIBC, where the corresponding blocks are color-scaled and then searched for the matched block. The luma and chroma values can be normalized to generate better prediction. The normalization factors for the luma and chroma components can be signaled. Alternatively, the normalization factor for the luma component and the luma/chroma scaling ratio can be signaled. While the color scaling is combined in the exemplary encoder in FIG. 12A, the color scaling can also be used in an encoder without RIBC. FIG. 12B illustrates an exemplary block diagram for a video decoder incorporating RIBC and color scaling according to an embodiment of the present invention. The encoder in FIG. 12B is similar to the encoder system in FIG. 4B except that the Inter prediction 1220 uses joint RIBC/IBC with Color Scaling 1222. Again, while the color scaling is combined with joint RIBC/IBC in the exemplary encoder in FIG. 12B, the color scaling can also be used in an encoder without RIBC.

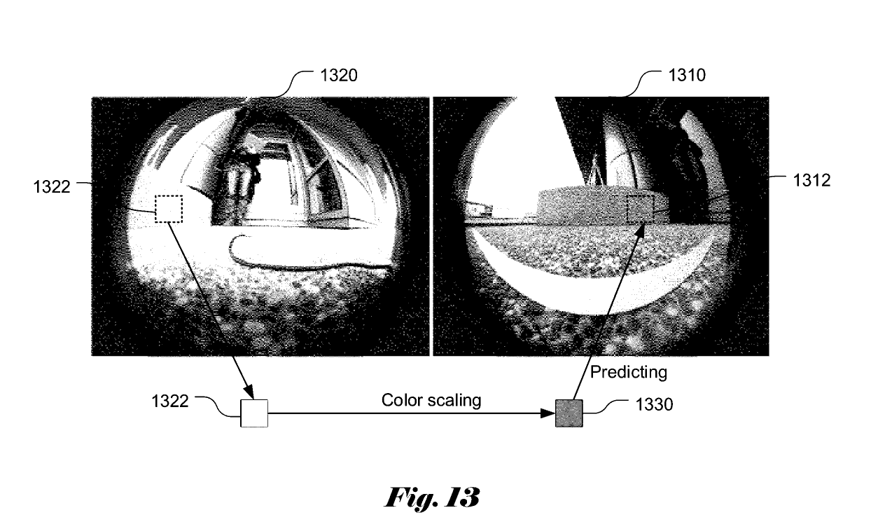

FIG. 13 illustrates an example of color scaling for compression of non-stitched pictures from two neighboring cameras with overlapped field of view. In FIG. 13, current block 1312 in current image 1310 and candidate block 1322 in image 1320 are two corresponding blocks in the overlapped area. The two corresponding areas 1322 and 1312 can be determined based on calibration data. Color scaling can be applied to block 1322 to generate a color-scaled block 1330. The color-scaled block 1330 is then used as a predictor for the target block 1312. A search process based on RIBC can be applied to determine a best matched block. In this case, block 1330 is considered as a candidate predictor for the current block 1312 and a best predictor is selected as the predictor for the target block 1312. An IBC search process may also be used to determine the best matched block without the remapping process for simplicity, which may be used for smaller block sizes.

Color scaling can be applied to a set of video data according to equation (1),

I′=a×I+b, (1)

where I is the original pixel intensity, I′ is the scaled intensity and a and b are scaling parameters, scaling factors or scaling coefficients. Equation (1) represents a linear model with a multiplication factor (i.e., a) and an offset value (i.e., b). There are various methods in the literature to derive the scaling parameters a and b. For example, the scaling parameters a and b can be derived from the pixel data of two corresponding areas by using techniques such as least squares estimation.

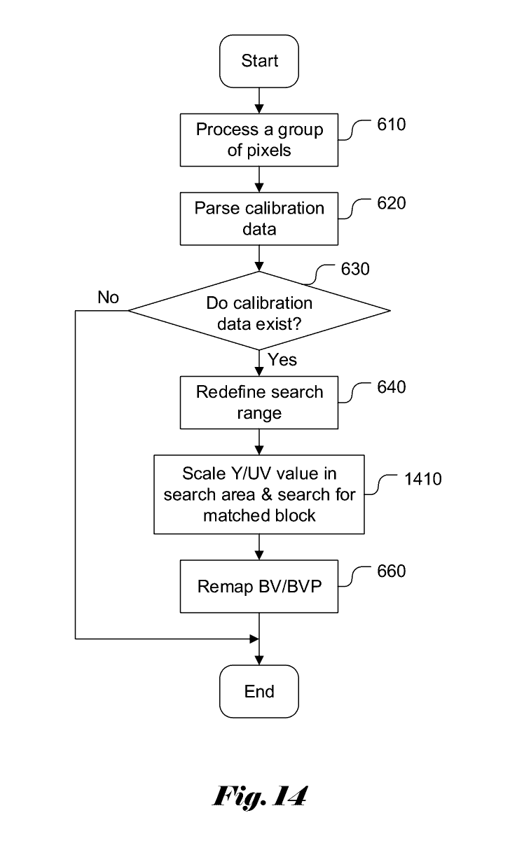

FIG. 14 illustrates an exemplary flowchart for an encoder incorporating a separate IBC and RIBC modes and the RIBC mode further includes color scaling as shown in FIG. 12A. The flowchart is substantially the same as that in FIG. 6, except that step 650 is replaced by step 1410. In step 1410, the pixel values are scaled using Y/UV scaling and the RIBC search is performed on the scaled search area to find the best match. In FIG. 14, the color scaling process is only applied to the RIBC path. However, in another embodiment, the color scaling process is also applied to the IBC path (i.e., the “no” path from step 630).

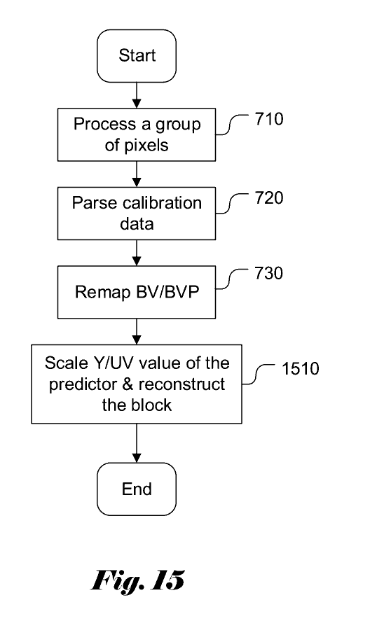

An exemplary flowchart for a decoder using the RIBC mode with color scaling is shown in FIG. 15. The flowchart is substantially the same as that in FIG. 7, except that step 740 is replaced by step 1510. In step 1510, the pixel values of the predictor are scaled using Y/UV scaling and the scaled predictor is used for reconstructing the block.

FIG. 16 illustrates an exemplary flowchart for an encoder incorporating a joint RIBC/IBC mode with color scaling for the encoder in FIG. 12B. The flowchart is substantially the same as that in FIG. 8, except that step 650 is replace by step 1410. In step 1410, the pixel values are scaled using Y/UV scaling and the RIBC search is performed on the scaled search area to find the best match. In this example, the color scaling is applied to the RIBC process only. However, the color scaling process can also be applied to the IBC process.

FIG. 17 illustrates an exemplary flowchart for a decoder corresponding to an encoder using a joint RIBC/IBC mode with color scaling as shown in FIG. 12B. The flowchart is substantially the same as that in FIG. 9, except that step 740 for RIBC (i.e., the “yes” path) is replaced by step 1510. In step 1510, the pixel values of the predictor are scaled using Y/UV scaling and the scaled predictor is used for reconstructing the block. For IBC decoding process, the same reconstruction process (i.e., step 740) is used as before. However, the color scaling process can also be applied to the IBC process.

In the example shown in FIG. 13, if the average values for Y, U and V components of block 1322 are 180, 30 and 50 respectively and the average values for Y, U and V components of block 1312 are 50, 30 and 50 respectively, the parameters (a, b) derived correspond to (0.25, 5), (1, 0) and (1, 0) for the Y, U and V components respectively. In other words, the Y/UV scaling are performed as follows:

Y′=Y×0.25+5,

U′=U×1+0,

V′=V×1+0,

where Y′, U′ and V′ are scaled Y, U and V components respectively.

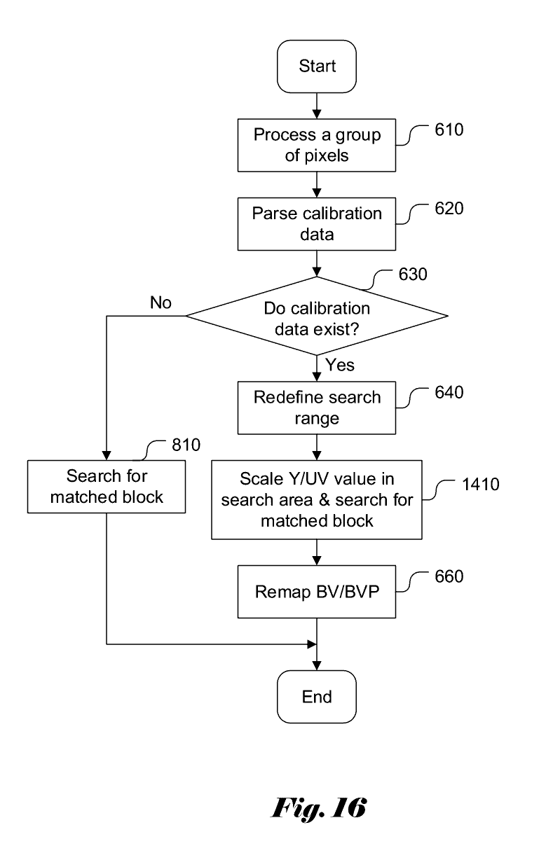

For panoramic applications, wide field-of-view (FOV) or fisheye lenses are often used. In these cases, contents are likely to noticeably distorted, which will decrease prediction efficiency in temporal Inter prediction and IBC prediction. For example, in FIG. 18, the areas indicated by two dashed ellipses (1810 and 1820) represent two corresponding areas including human subjects and structures. However, both the human subjects and structures are distorted with respect to each other. If prediction is performed directly using the corresponding area, the prediction will result in substantial prediction residuals. In order to overcome the distortion issue, the present invention also discloses a projection-based prediction technique.

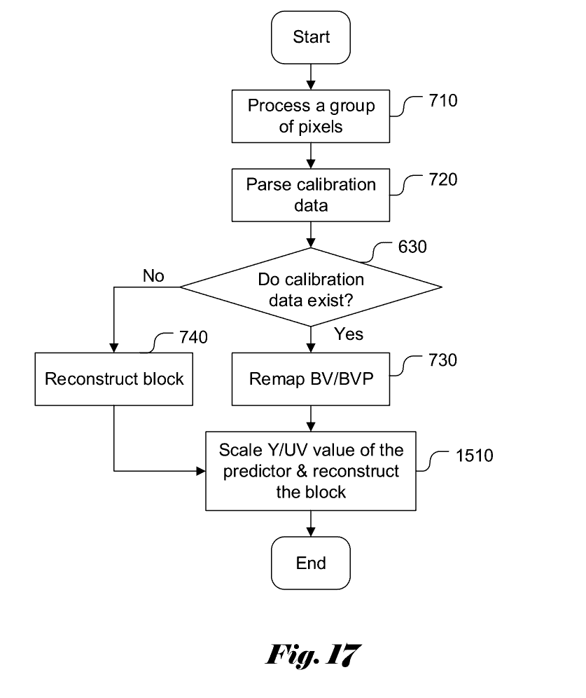

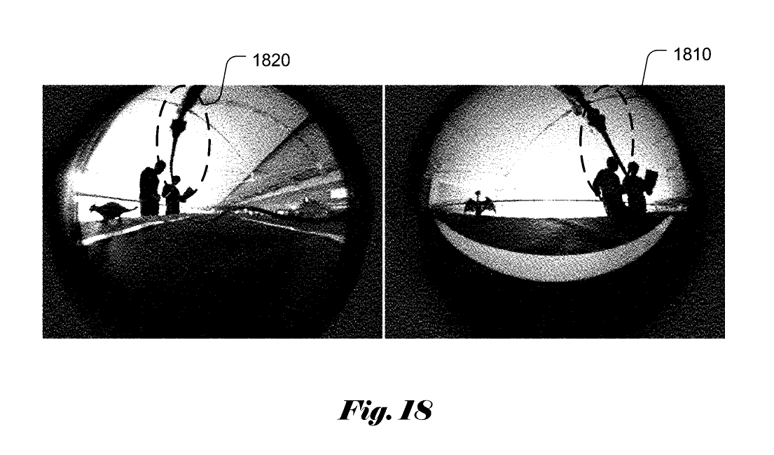

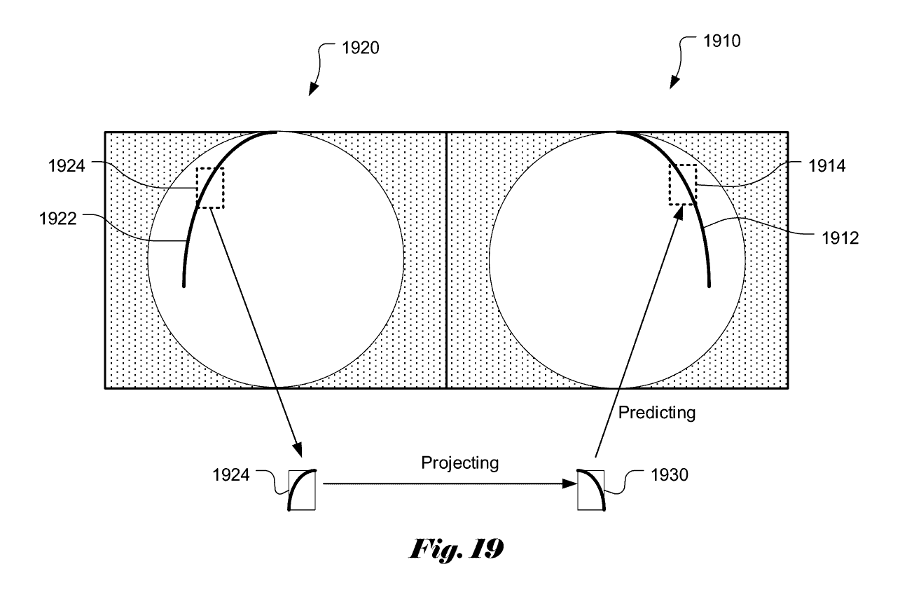

FIG. 19 illustrates the concept of the projection-based prediction technique. The right part of image 1910 and the left part of image 1920 correspond to overlapped area. A feature 1912 in image 1910 may look differently from the corresponding feature 1922 in image 1920 due to the distortion caused by the wide FOV or fisheye lenses. According to the projection-based prediction technique, two corresponding blocks 1914 and 1924 are identified in images 1910 and 1920 respectively. The block 1924 is projected using camera parameters to a projected block 1930 and the projected block 1930 is used to predict the target block 1914.

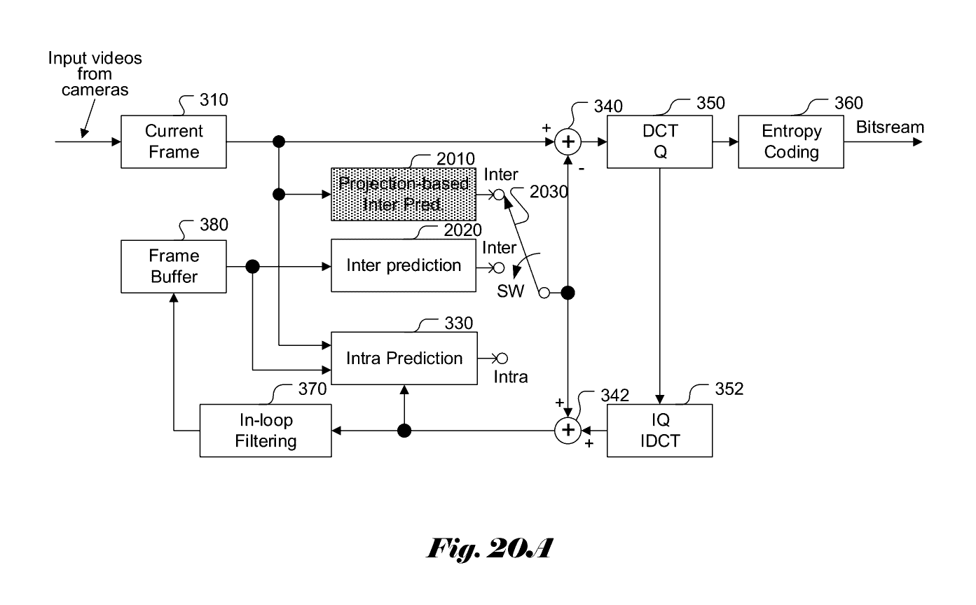

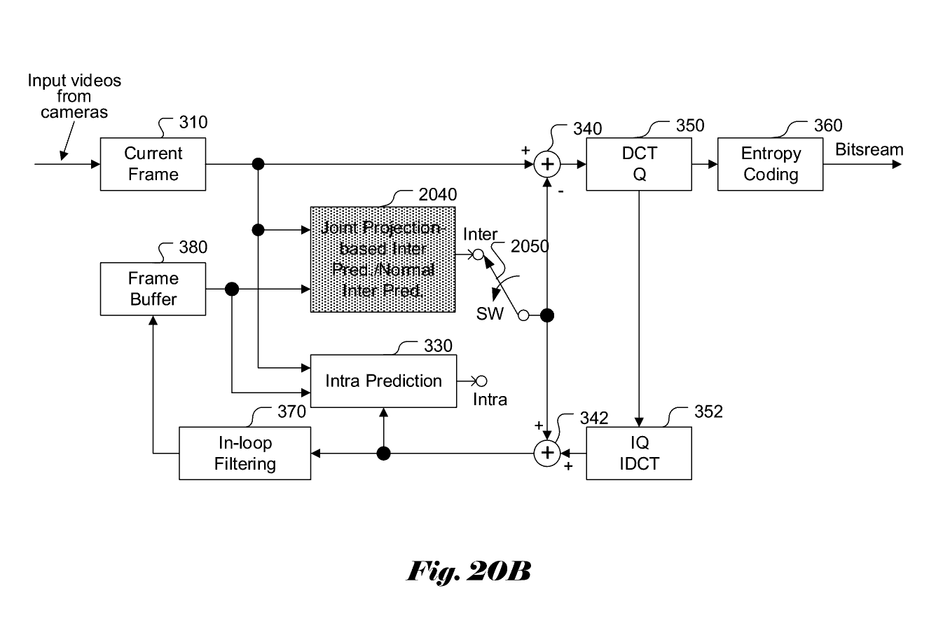

FIG. 20A illustrates an exemplary block diagram for a video encoder incorporating projection-based prediction according to an embodiment of the present invention. The encoder system in FIG. 20A is similar to the system in FIG. 4A except that the Inter prediction 410 in FIG. 4A is replaced by the projection-based prediction 2010 and a regular Inter prediction 2020. The switch SW 2030 selects among the three modes (i.e., two Inter modes and one Intra mode).

FIG. 20B illustrates an exemplary block diagram for another video encoder incorporating projection-based prediction according to an embodiment of the present invention. The system in FIG. 20B is similar to that in FIG. 20A. However, the two Inter modes (2010 and 2020) are combined into a joint projection-based Inter prediction and normal Inter prediction 2040. Switch SW 2050 selected between this joint Inter mode 2040 and the Intra mode 330.

The projection-based prediction can be used for the spatial domain and the temporal domain. For the spatial domain, a translation matrix is used to represent position relation between the two cameras with overlapped FOV. For the temporal domain, the translation matrix is used to represent global motion (3D). The translation matrix can be obtained from calibration data or matching results, where the calibration data involves intrinsic and extrinsic parameters. The translation matrix calculation is known in the art and the details are not repeated herein. For 3D motion model, the motion may correspond to roll, pitch and yaw. For each motion model, the corresponding translation matrix can be calculated. The translation matrix can be generated before encoding or during the encoding stage. Matching results involves feature detection or block matching results. Usually, feature/block matching derivation is performed in the encoder side.

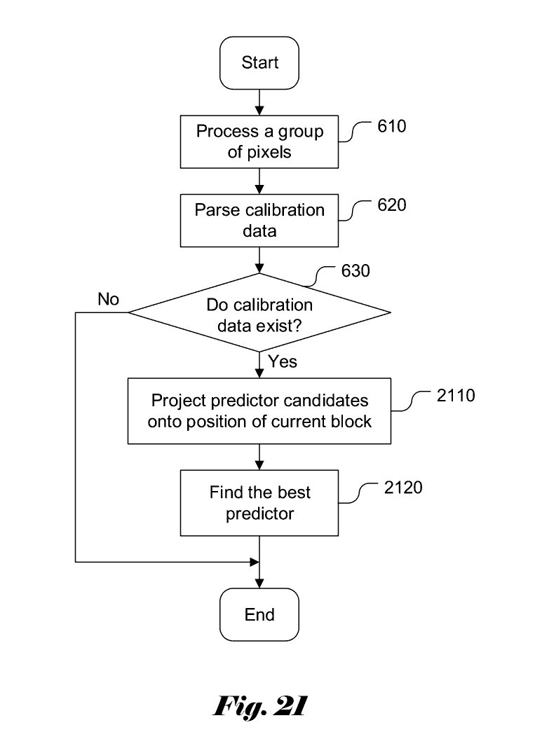

FIG. 21 illustrates an exemplary flowchart for an encoder in FIG. 20A and the flowchart corresponds to the case when the projection-based prediction is selected. The flowchart is similar to that in FIG. 6 for steps 610 through 630. However, when the calibration data exist (i.e., the “yes” path from step 630), steps 2110 and 2120 are performed. In step 2110, the predictor candidates are projected onto the position of current block using the calibration data. The best predictor is found among the projected predictor candidates as shown in step 2120.

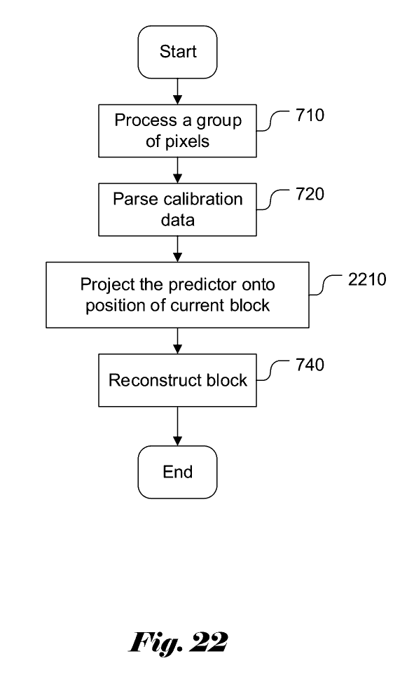

FIG. 22 illustrates an exemplary flowchart for a decoder corresponding to the encoder in FIG. 20A and the flowchart corresponds to the case when the projection-based prediction is selected. The flowchart is similar to that in FIG. 7 for steps 710 and 720. However, after the calibration data are parsed, step 2210 is performed. In step 2210, the predictor is projected onto the position of the current block.

FIG. 23 illustrates an exemplary flowchart for an encoder in FIG. 20B, where a joint projection-based Inter prediction and normal Inter prediction mode is used. The flowchart is similar to that in FIG. 8 for steps 610 through 630. However, when the calibration data exist (i.e., the “yes” path from step 630), steps 2110 and 2120 are performed. When the calibration data do not exist (i.e., the “no” path from step 630), step 2310 is performed. In step 2310, the normal Inter prediction is performed.

FIG. 24 illustrates an exemplary flowchart for a decoder corresponding to the encoder in FIG. 20B. The flowchart is similar to that in FIG. 9 and includes steps 710, 720, 630 and 740. However, if the calibration data exist (i.e., the “yes” path from step 630), step 2210 is performed.

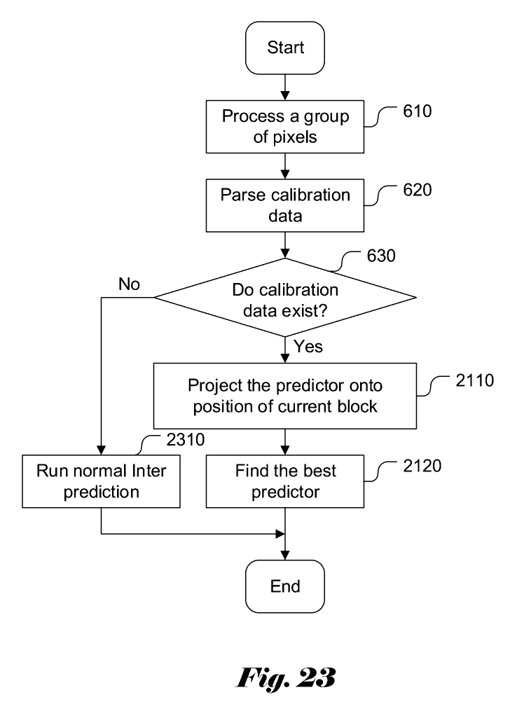

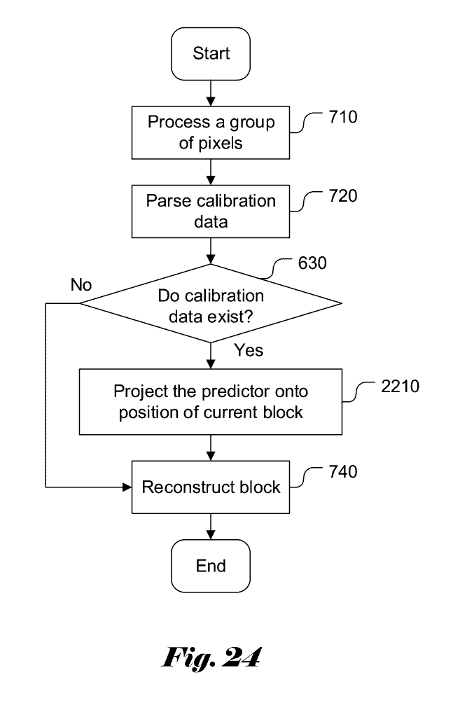

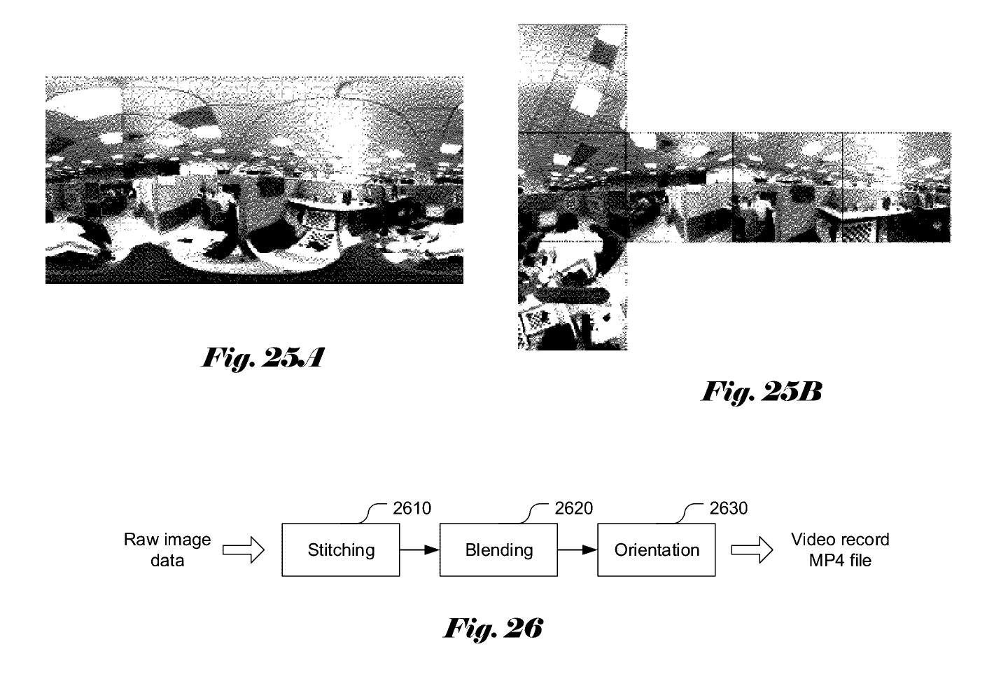

The present invention also addresses various issues associated 360-degree video, such as video format, transmission and representation. As mentioned before, a 360-degree video may be created with a spherical camera system that simultaneously records 360 degrees FOV of a scene. The image types of 360-degree video include equirectangular and cubic projections. The equirectangular projection is a type of projection for mapping a portion of the surface of a sphere to a flat image. According to the equirectangular projection, the horizontal coordinate is simply longitude, and the vertical coordinate is simply latitude. There is no transformation or scaling applied to the equirectangular projection. FIG. 25A illustrates an example of a 360-degree picture based on the equirectangular projection. On the other hand, the cubic projection is a type of projection for mapping the surface of a sphere onto six faces of a cube. The images are arranged like the faces of a cube. FIG. 25B illustrates an example of a 360-degree picture based on the cubic projection. In order to properly use the 360-degree video, it requires to include 360-degree video metadata associated with the 360-degree video. Today, there are some social websites that can distinguish uploaded 360-degree videos by 360-degree video metadata and support equirectangular projections browsing.

The 360-degree video metadata typically include information such as projection type, stitching software, capture software, pose degrees, view degrees, source photo count, cropped width, cropped height, full width, full height, etc. There are two types of 360-degree video metadata needed to represent various characteristics of a spherical video: Global and Local metadata. Global metadata is usually stored in an XML (Extensible Markup Language) format. These are two types of local metadata including the strictly per-frame metadata and arbitrary local metadata (e.g. information sampled at certain intervals).

The processing for the 360-degree video always is very time consuming due to complexity of the processing and the large quantity of data to be processed. Accordingly, an embodiment of the present invention stores the 360-degree video in the raw image type. Therefore, without image signal processing before video recording, the frame rate can be substantially increased.

In order to have the better 360-degree video experience, the video resolution has been continuously been challenged to push for higher and image processing is continuously evolving to stride for more video fidelity. The processing flow includes stitching, blending, and rotation. It is difficult for general users to handle those tasks. According to another embodiment of the present invention, the camera and ISP parameters are stored along with the 360-degree video bitstream. Based on the parameters stored, third parties are allowed to process images offline to get the best quality video.

FIG. 26 illustrates an example of spherical video pre-processing flow. The raw images are stitched using stitching process 2610. The blending process 2620 is then applied to the stitched images. According to a desired orientation, the blended picture is generated using the orientation process 2630. Since the image processing algorithms for 360-degree videos are performed offline, there is no need for expensive and powerful hardware for the raw image capture device to record and stitch the video in real time. The captured video can be uploaded to designated websites for cloud-based processing. The processed 360-degree video can be at end user devices (e.g. computer, tablet and smart phone). According to the network bandwidth, the cloud environment may provide video with different qualities.

According to the present invention, a 360-degree video of a scene is recorded using a 360-degree video capture device. The 360-degrees video is stored in the raw images. Also, the 360-degrees video bitstream includes the camera parameters and the parameters for image signal processing (ISP). The camera and ISP parameters can be stored in the file metadata or anywhere in the 360-video bit-stream. FIG. 27 illustrates an example of cloud-based processing of 360-degree video according to one embodiment of the present invention, where the video data captured by a 360-degree video capture camera 2710 is uploaded to the cloud 2720. The cloud environment has more computational resources and can provide processed video with different quality according to the network bandwidth. Depending on the available network bandwidth and the specific characteristics (e.g. display resolution) of end receiving devices (e.g. mobile phone 2732, tablet 2734 and computer 2736).

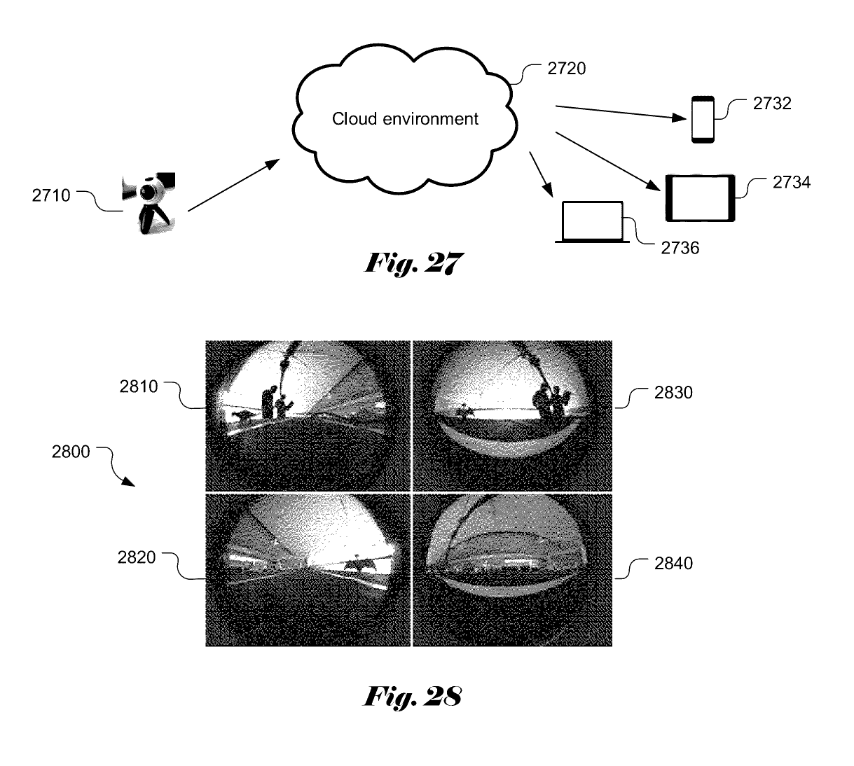

For 360-degree video, each frame in the video consists of multiple images captured by multiple cameras arranged to cover 360-degree field of view (FOV). The 360-degree video source bitstream comprises of a sequence of frames and camera parameters, such as intrinsic calibration parameters, extrinsic calibration parameters, exposure value (EV), field of view (FOV) and the direction associated with the cameras. According to an embodiment of the present invention, the sequence of frames is stored in a raw data format so that the 360-degree video can be recorded at a high frame rate. The directions can be represented as Euler angles, polar or Cartesian coordinate system. FIG. 28 illustrates and example of a frame of 360-degree video, where the 2800 frame consists of four images (2810, 2820, 2830 and 2840).

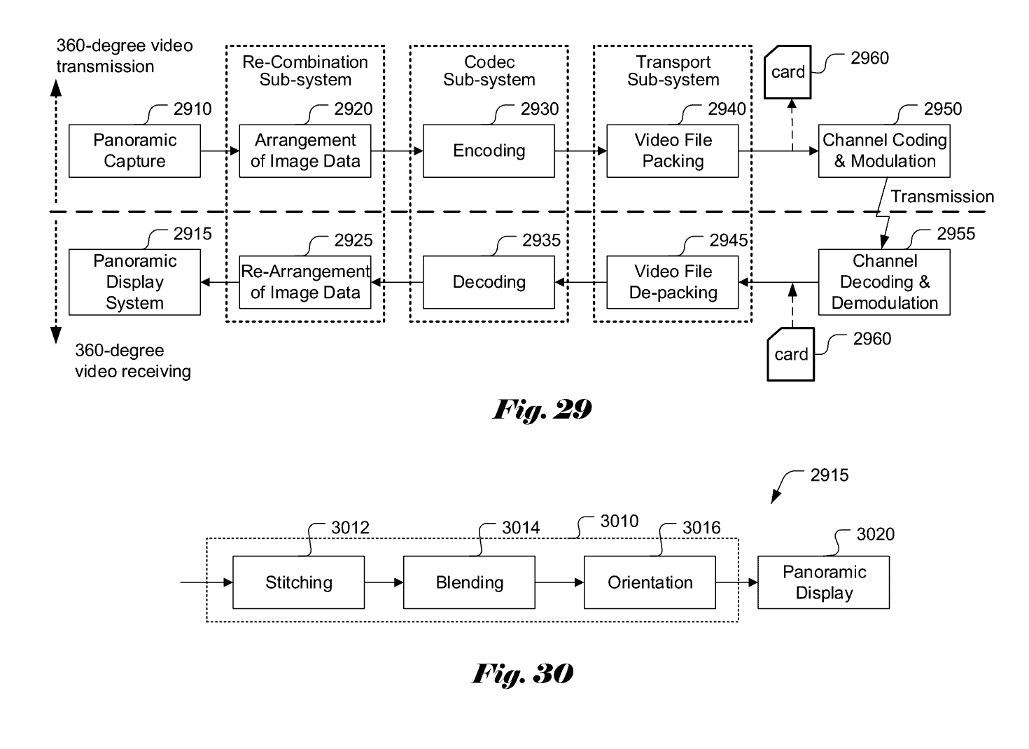

FIG. 29 illustrates an example of the 360-degree video transmission system. On the transmission side, a panoramic capture subsystem 2910 captures a 360-degree video sequence. The captured 360-degree video sequence is processed by a process for arranging image data 2920 that combines images from different cameras into a frame, an encoding process 2930 that compresses the image data and a video file packing process 2940 that packs the compressed image data into a format suitable for storage or transmission. The video file packing process 2940 may also include other information related to the image data. The 360-degree video file from the video file packing process 2940 can be transmitted through a wired media or wireless channel. In this case, channel coding and modulation 2950 suited for the wired media or wireless channel is used. Alternatively, the 360-degree video file can also be stored in a storage device such as a memory card 2960. In the receiving side, the reverse actions will be performed. For example, channel decoding and demodulation 2955 will be used to receive the data of the 360-degree video file from the wired media or wireless channel. A video file de-packing process 2945 will extract compressed image data and related information from the file. A decoding process 2935 is used to decode the compressed image data and the decoded video is processed by image re-arranging process 2925, which will re-arrange the decoded images. The re-arranged 360-degree video is then displayed using a panoramic display system 2915.

The panoramic display system 2915 includes panoramic post-processing unit 3010 and a panoramic display subsystem 3020 as shown in FIG. 30. Panoramic post-processing may include stitching 3012, blending 3014, and orientation process 3016. Panoramic post-processing may further include white balance to adjust colors.

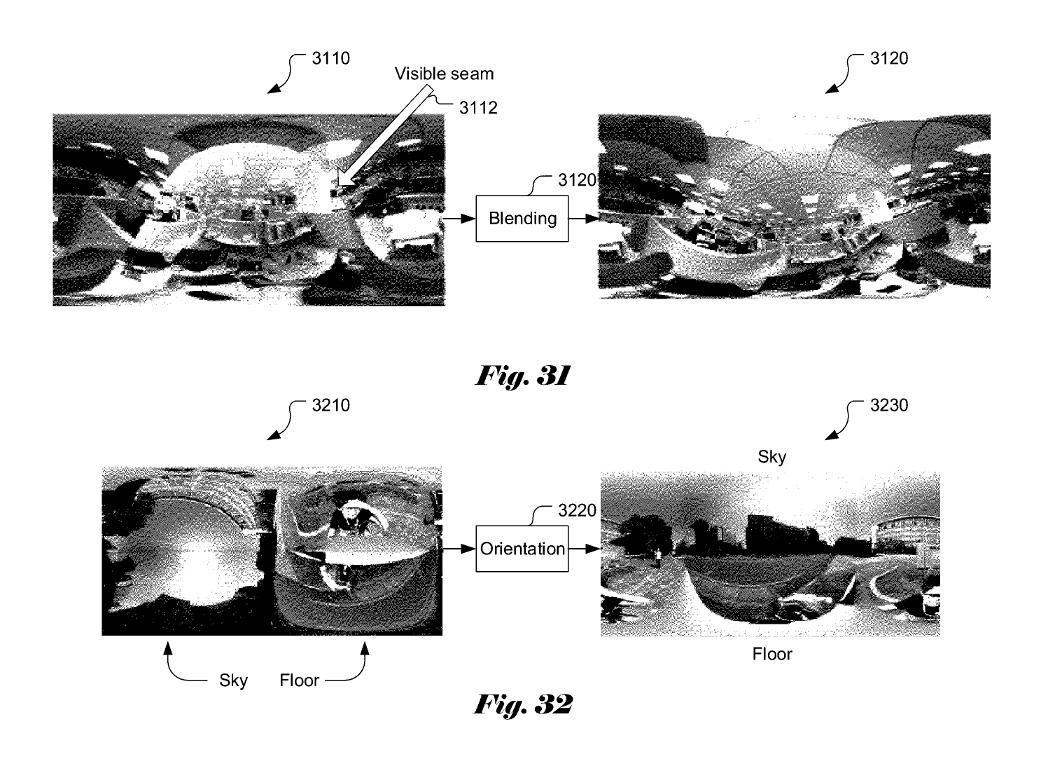

Techniques related to image stitching has been well studied in the field of panoramic image processing. However, the stitching techniques often still result in stitched image with imperfection or artefacts such as visible seams. Therefore, blending is always used to improve the visual quality of the stitched picture. According to the present invention, the 360-degree video metadata may also include information regarding the blending methods, such as GIST, Pyramid, and Alpha blending, that users can select. GIST stitching corresponds to GIST: Gradient-domain Image STitching. All these blending methods are well known in the field and the details are not repeated in this disclosure. The 360-degree video metadata may also include information related to stitching positions, which is defined as the seam between the images captured by different cameras. The Information of stitching position can be coordinate values or equation coefficients of a polynomial function that represents the curve of the stitching seam. FIG. 31 illustrates an example of effect of blending process. Picture 3110 represents a stitched picture prior blending and a seam 3112 is visible. A blending process 3120 can be applied to picture 3110 with information associated with a user selected blending method and stitching position. An embodiment of the present invention incorporates the needed blending information in the video recording/transmission side. For example, the stitching position for each frame and the blending method can be provided to video file packing process 2940 in FIG. 29. At the video decoding/receiving side, the stitching position for each frame and the blending method can be extracted using video file de-packing process 2945 in FIG. 29 and the extracted stitching position for each frame and the blending method are provided to the blending process 3014 within the panoramic post processing 3010.

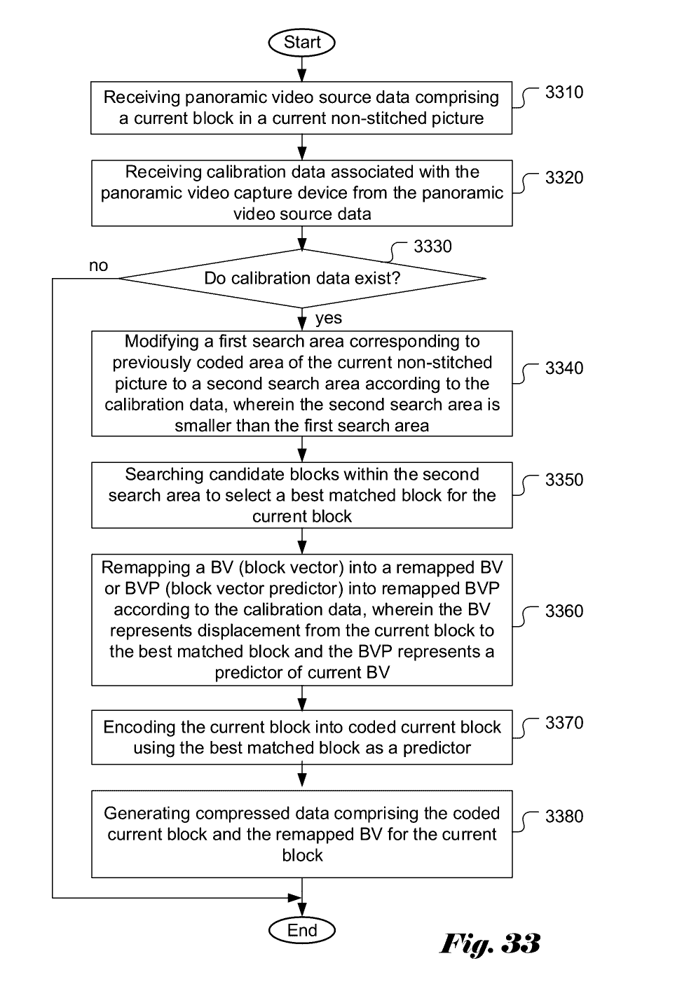

According to another embodiment of the present invention, the 360-degree video metadata may also include sensor values associated with captured frames. The sensor, such as Gyro-Sensor or G Sensor, is used to measure the phone direction and/or orientation. The sensor value can be based on Euler angles, polar, or Cartesian coordinate systems. An embodiment of the present invention incorporates the needed position/orientation values in the video recording/transmission side. For example, the position/orientation values can be provided to video file packing process 2940 in FIG. 29. At the video decoding/receiving side, the position/orientation values can be extracted using video file de-packing process 2945 in FIG. 29 and the extracted position/orientation values are provided to the orientation process 3016 within the panoramic post processing 3010 to generate panoramic display with a desired orientation. The method to generate a 3D display with a desired orientation is known in the field and the details are not repeated in this disclosure. FIG. 32 illustrates an example of orientation process to generate a panoramic display at a desired orientation. Picture 3210 corresponds to a stitched picture corresponding to downward view on the right and an upward view on the left. The orientation process 3220 can orient the panoramic display to the correct orientation as shown in picture 3230 with the orientation data associated with the 360-degree video data.

According to another embodiment of the present invention, the 360-degree video metadata may include environment information, such as luminance (Y), chroma (UV), red brightness, blue brightness, green brightness per frame, or color temperature of the environment. The environment information comes from RGB light sensors. The information related to the environmental lighting condition is useful for adjusting the captured images, such as white balance or background color adjustment, to correct any possible color artefact. When the white balance or background color adjustment is included in the panoramic post processing, it may be performed before or after stitching/blending. An embodiment of the present invention incorporates the information related to the environmental lighting condition in the video recording/transmission side. For example, the position/orientation values can be provided to video file packing process 2940 in FIG. 29. At the video decoding/receiving side, the information related to the environmental lighting condition can be extracted using video file de-packing process 2945 in FIG. 29 and the extracted information related to the environmental lighting condition are provided to the white balance or background color adjustment within the panoramic post processing 3010 to generate panoramic display with a desired orientation.

FIG. 33 illustrates an exemplary flowchart of video encoding of non-stitched pictures using a remapping IBC mode in a video encoder according to an embodiment of the present invention. The encoder receives panoramic video source data comprising a current block in a current non-stitched picture in step 3310. The encoder also receives calibration data associated with the panoramic video capture device from the panoramic video source data in step 3320. Whether the calibration data exist is checked in step 3330. If the calibration data exist (i.e., the “yes” path from step 3330), steps 3340 through 3380 are performed. Otherwise (i.e., the “no” path from step 3330), steps 3340 through 3380 are skipped. In step 3340, a first search area corresponding to previously coded area of the current non-stitched picture is modified to a second search area according to the calibration data and the second search area is smaller than the first search area. In step 3350, candidate blocks within the second search area are searched to select a best matched block for the current block. In step 3360, a BV (block vector) is remapped into a mapped BV or a BVP (block vector predictor) into mapped BVP according to the calibration data, where the BV represents displacement from the current block to the best matched block and the BVP represents a predictor of current BV. In step 3370, the current block is encoded into coded current block using the best matched block as a predictor. In step 3380, compressed data comprising the coded current block and the mapped BV for the current block are generated.

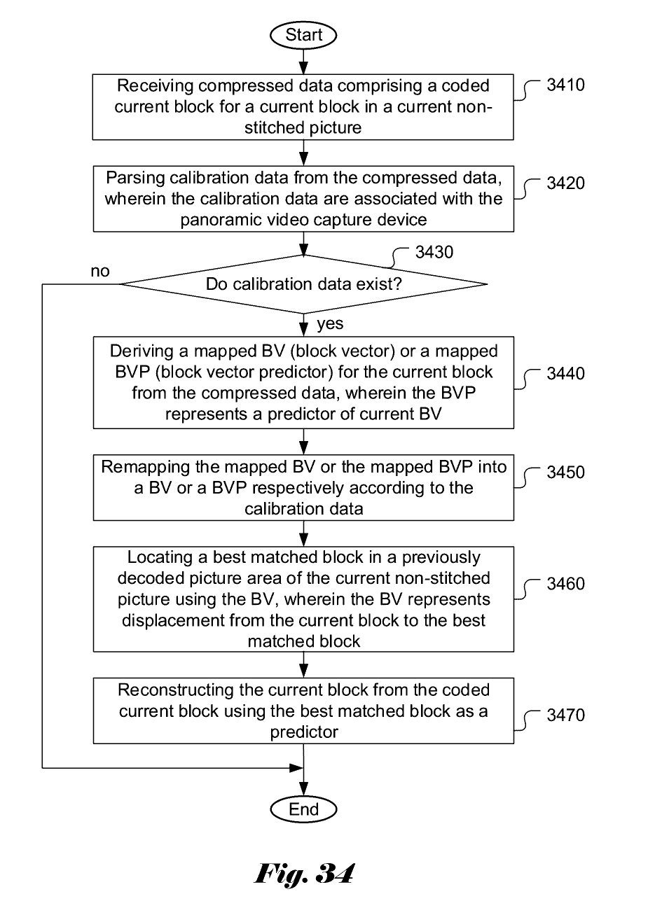

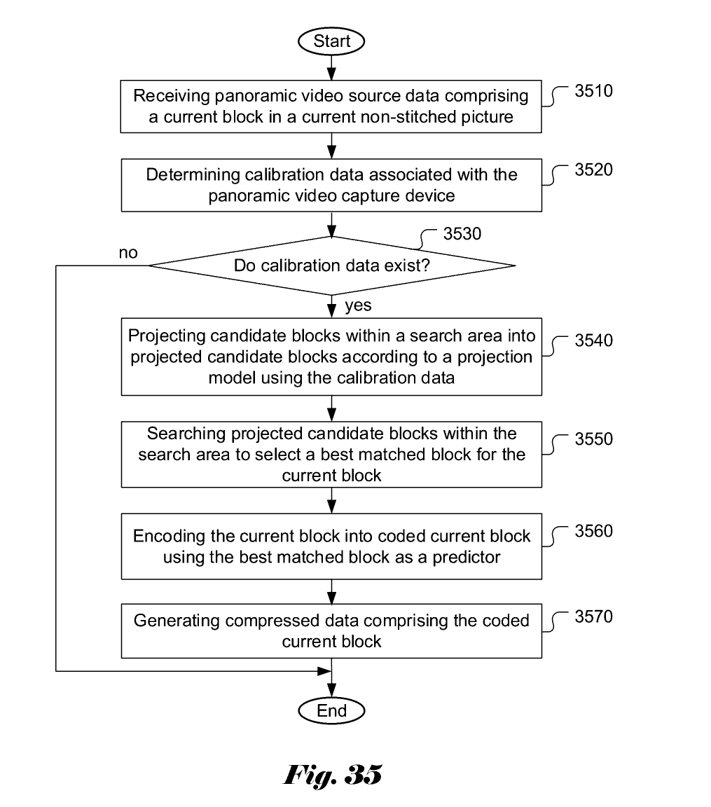

FIG. 34 illustrates an exemplary flowchart of video decoding of non-stitched pictures using a remapping IBC mode in a video decoder according to an embodiment of the present invention. The decoder receives compressed data comprising a coded current block for a current block in a current non-stitched picture in step 3410. The decoder parses calibration data from the compressed data in step 3420, where the calibration data are associated with the panoramic video capture device. Whether the calibration data exist is checked in step 3430. If the calibration data exist (i.e., the “yes” path from step 3430), steps 3440 through 3470 are performed. Otherwise (i.e., the “no” path from step 3430), steps 3440 through 3470 are skipped. In step 3440, a mapped BV (block vector) or a mapped BVP (block vector predictor) for the current block is derived from the compressed data, where the BVP represents a predictor of current BV. In step 3450, the mapped BV or a mapped BVP (block vector predictor) is remapped into a BV or a MVP according to the calibration data. In step 3460, the best matched block in a previously decoded picture area of the current non-stitched picture is located using the BV, where the BV represents displacement from the current block to the best matched block. In step 3470, the current block is reconstructed from the coded current block using the best matched block as a predictor.

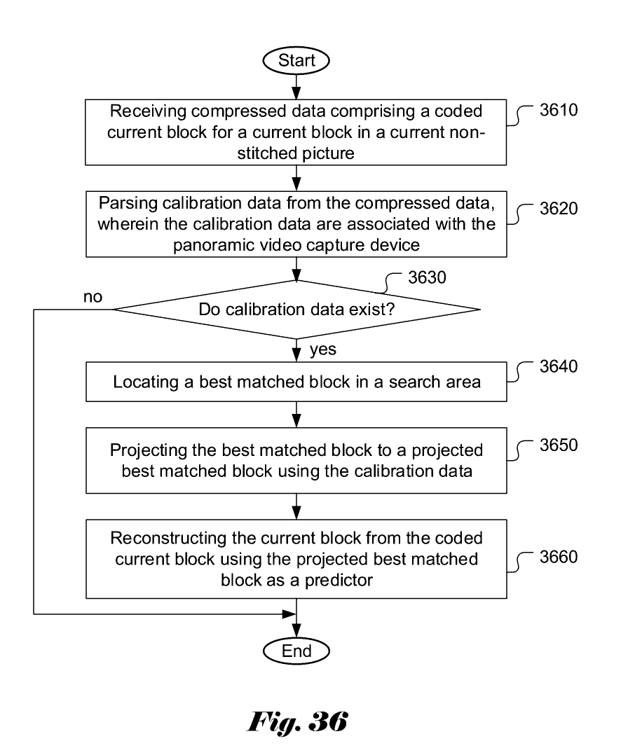

FIG. 35 illustrates an exemplary flowchart of video encoding of non-stitched pictures using a projection-based Inter prediction mode in a video encoder according to an embodiment of the present invention. The encoder receives panoramic video source data comprising a current block in a current non-stitched picture in step 3510. The encoder also receives calibration data associated with the panoramic video capture device from the panoramic video source data in step 3520. Whether the calibration data exist is checked in step 3530. If the calibration data exist (i.e., the “yes” path from step 3530), steps 3540 through 3570 are performed. Otherwise (i.e., the “no” path from step 3530), steps 3540 through 3570 are skipped. In step 3540, candidate blocks within a search area are projected into projected candidate blocks according to a projection model using the calibration data. In step 3550, projected candidate blocks within the search area are searched to select a best matched block for the current block. In step 3560, the current block is encoded into coded current block using the best matched block as a predictor. In step 3570, compressed data comprising the coded current block is generated.

FIG. 36 illustrates an exemplary flowchart of video decoding of non-stitched pictures using a projection-based Inter prediction mode in a video decoder according to an embodiment of the present invention. The decoder receives compressed data comprising a coded current block for a current block in a current non-stitched picture in step 3610. The decoder parses calibration data from the compressed data in step 3620, where the calibration data are associated with the panoramic video capture device. Whether the calibration data exist is checked in step 3630. If the calibration data exist (i.e., the “yes” path from step 3630), steps 3640 through 3660 are performed. Otherwise (i.e., the “no” path from step 3630), steps 3640 through 3660 are skipped. In step 3640, a best matched block in a search area is located. The best matched can be located based on a block vector (BV) associated with the current block. If remapped IBC is used, a mapped BV may be used to locate the best matched block. In step 3650, the best matched block is projected to a projected best matched block using the calibration data. In step 3660, the current block is reconstructed from the coded current block using the projected best matched block as a predictor.

The flowcharts shown above are intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video encoding of non-stitched pictures for a video encoding system, wherein each non-stitched picture comprises at least two images captured by two cameras of a panoramic video capture device, and wherein two neighboring images captured by two neighboring cameras include at least an overlapped image area, the method comprising:
receiving panoramic video source data comprising a current block in a current non-stitched picture;
receiving calibration data associated with the panoramic video capture device from the panoramic video source data, wherein the calibration data comprise camera parameters, feature detection results, or both; and
when the calibration data exist, applying an encoding process to the current block by utilizing the calibration data for at least one operation of the encoding process.

2. The method of claim 1, wherein the encoding process comprises encoding the current block using a RIBC (Remapped Intra Block Copy) encoding process comprising:
modifying a first search area corresponding to previously coded area of the current non-stitched picture to a second search area according to the calibration data, wherein the second search area is smaller than the first search area;
searching candidate blocks within the second search area to select a best matched block for the current block;
remapping a BV (block vector) into a mapped BV or BVP (block vector predictor) into mapped BVP according to the calibration data, wherein the BV represents displacement from the current block to the best matched block and the BVP represents a predictor of current BV;
encoding the current block into coded current block using the best matched block as a predictor; and
generating compressed data comprising the coded current block and the mapped BV for the current block.

3. The method of claim 2, wherein the calibration data comprise one or more camera parameters, one or more feature detection results, or both that are generated during camera calibration stage, and wherein said one or more camera parameters are selected from a first group comprising principal points, camera position, FOV (field of view), intrinsic parameters and extrinsic parameters, and said one or more feature detection results are selected from a second group comprising feature position and matching relation.

4. The method of claim 2, wherein the calibration data are parsed from the panoramic video source data.

5. The method of claim 2, wherein the RIBC encoding process further includes a color scaling process to process candidate blocks for selecting the best matched block, and wherein the color scaling process comprises:
scaling pixel values for each color component according to a scaling formula to generate scaled pixel values, wherein the scaling formula is specified by one or more scaling parameters.

6. The method of claim 1, wherein the encoding process comprises:
receiving panoramic video source data comprising a current block in a current non-stitched picture;
determining calibration data associated with the panoramic video capture device;
when the calibration data exist, encoding the current block using a projection-based Inter prediction mode, wherein projection-based Inter prediction encoding process comprises:
projecting candidate blocks within a search area into projected candidate blocks according to a projection model using the calibration data;
searching projected candidate blocks within the search area to select a best matched block for the current block;
encoding the current block into coded current block using the best matched block as a predictor; and
generating compressed data comprising the coded current block.

7. The method of claim 6, wherein the calibration data comprise one or more camera parameters, one or more feature detection results, or both that are generated during camera calibration stage, and wherein said one or more camera parameters are selected from a first group comprising principal points, camera position, FOV (field of view), intrinsic parameters and extrinsic parameters, and said one or more feature detection results are selected from a second group comprising feature position and matching relation.

8. The method of claim 6, wherein the calibration data are parsed from the panoramic video source data.

9. The method of claim 6, wherein the search area is within a previously coded area of the current non-stitched picture.

10. The method of claim 9, wherein said projecting candidate blocks within the search area into projected candidate blocks applies a translation matrix to the candidate blocks, and wherein the translation matrix represents position relation between two neighboring cameras of the panoramic video capture device.

11. The method of claim 6, wherein the search area is within a reference non-stitched picture that is coded prior to the current non-stitched picture.

12. The method of claim 11, wherein said projecting candidate blocks within the search area into projected candidate blocks applies a translation matrix to the candidate blocks, and wherein the translation matrix represents global motion of non-stitched pictures.

13. An apparatus for video encoding of non-stitched pictures in a video encoding system, wherein each non-stitched picture comprises at least two images captured by two cameras of a panoramic video capture device, and wherein two neighboring images captured by two neighboring cameras include at least an overlapped image area, the apparatus comprising one or more electronic circuits or processors arranged to:
receive panoramic video source data comprising a current block in a current non-stitched picture;
receiving calibration data associated with the panoramic video capture device from the panoramic video source data; and
when the calibration data exist, apply an encoding process to the current block by utilizing the calibration data for at least one operation of the encoding process.

14. The apparatus of claim 13, wherein said one or more electronic circuits or processors are further arranged to:
encode the current block using a RIBC (Remapped Intra Block Copy) encoding process comprising:
modify a first search area corresponding to previously coded area of the current non-stitched picture to a second search area according to the calibration data, wherein the second search area is smaller than the first search area;
search candidate blocks within the second search area to select a best matched block for the current block;
remapping a BV (block vector) into a mapped BV or BVP (block vector predictor) into mapped BVP according to the calibration data, wherein the BV represents displacement from the current block to the best matched block and the BVP represents a predictor of current BV;
encode the current block into coded current block using the best matched block as a predictor; and
generate compressed data comprising the coded current block and the mapped BV for the current block.

15. The apparatus of claim 13, wherein said one or more electronic circuits or processors are further arranged to:
encode the current block using a projection-based Inter prediction mode comprising:
project candidate blocks within a search area into projected candidate blocks according to a projection model using the calibration data;
search projected candidate blocks within the search area to select a best matched block for the current block;
encode the current block into coded current block using the best matched block as a predictor; and
generate compressed data comprising the coded current block.

16. A method of video decoding for non-stitched pictures in a video decoding system, wherein each non-stitched picture comprises at least two images captured by two cameras of a panoramic video capture device, and wherein two neighboring images captured by two neighboring cameras include at least an overlapped image area, the method comprising:
receiving compressed data comprising a coded current block for a current block in a current non-stitched picture;
parsing calibration data from the compressed data, wherein the calibration data are associated with the panoramic video capture device, and the calibration data comprise camera parameters, feature detection results, or both; and
when the calibration data exist, applying a decoding process to the current block utilizing the calibration data for at least one operation of the decoding process.

17. The method of claim 16, wherein the decoding process comprises a RIBC (Remapped Intra Block Copy) decoding process comprising:
deriving a mapped BV (block vector) or a mapped BVP (block vector predictor) for the current block from the compressed data, wherein the BVP represents a predictor of current BV;
remapping the mapped BV or the mapped BVP into a BV or a BVP respectively according to the calibration data;
locating a best matched block in a previously decoded picture area of the current non-stitched picture using the BV, wherein the BV represents displacement from the current block to the best matched block; and
reconstructing the current block from the coded current block using the best matched block as a predictor.

18. The method of claim 17, wherein the calibration data comprise one or more camera parameters, one or more feature detection results, or both that are generated during camera calibration stage, and wherein said one or more camera parameters are selected from a first group comprising principal points, camera position, FOV (field of view), intrinsic parameters and extrinsic parameters, and said one or more feature detection results are selected from a second group comprising feature position and matching relation.

19. The method of claim 17, wherein the RIBC decoding process further includes a color scaling process to process the best matched block, and wherein the color scaling process comprises:
scaling pixel values for each color component according to a scaling formula to generate scaled pixel values, wherein the scaling formula is specified by one or more scaling parameters.

20. The method of claim 16, wherein the decoding process comprises a projection-based Inter prediction decoding process comprising:
locating a best matched block in a search area;
projecting the best matched block to a projected best matched block using the calibration data; and
reconstructing the current block from the coded current block using the projected best matched block as a predictor.

21. The method of claim 20, wherein the search area is within a previously coded area of the current non-stitched picture, and a BV (block vector) or a BVP (BV predictor) is used to locate the best matched block.

22. The method of claim 21, wherein the best matched block is projected into a projected best matched block using a translation matrix representing position relation between two neighboring cameras of the panoramic video capture device.

23. The method of claim 20, wherein the search area is within a reference non-stitched picture that is coded prior to the current non-stitched picture.

24. The method of claim 23, wherein the best matched block is projected into a projected best matched block using a translation matrix representing global motion of non-stitched pictures.

25. An apparatus for video decoding of non-stitched pictures in a video decoder, wherein each non-stitched picture comprises at least two images captured by two cameras of a panoramic video capture device, and wherein two neighboring images captured by two neighboring cameras include at least an overlapped image area, the apparatus comprising one or more electronic circuits or processors arranged to:
receive compressed data comprising a coded current block for a current block in a current non-stitched picture;
parse calibration data from the compressed data, wherein the calibration data are associated with the panoramic video capture device, and the calibration data comprise camera parameters, feature detection results, or both; and
when the calibration data exist, apply a decoding process to the current block utilizing the calibration data for at least one operation of the decoding process.

26. The apparatus of claim 25, wherein said one or more electronic circuits or processors are further arranged to:
derive a mapped BV (block vector) or a mapped BVP (block vector predictor) for the current block from the compressed data, wherein the BVP represents a predictor of current BV;
remap the mapped BV or the mapped BVP into a BV or a BVP respectively according to the calibration data;
locate a best matched block in a previously decoded picture area of the current non-stitched picture using the BV, wherein the BV represents displacement from the current block to the best matched block; and
reconstruct the current block from the coded current block using the best matched block as a predictor.

27. The apparatus of claim 25, wherein said one or more electronic circuits or processors are further arranged to:
receive compressed data comprising a coded current block for a current block in a current non-stitched picture;
parse calibration data from the compressed data, wherein the calibration data are associated with the panoramic video capture device;
when the calibration data exist, decode the current block using a projection-based Inter prediction mode, wherein projection-based Inter prediction decoding process comprises:
locate a best matched block in a search area; and
project the best matched block to a projected best matched block using the calibration data; and
reconstruct the current block from the coded current block using the projected best matched block as a predictor.
